(19) United States
(12) Patent Application Publication
(10) Pub. No.: US 2026/0270851 A1
(43) Pub. Date: Sep. 10, 2026

(54) USER EQUIPMENT (UE)

(71) Applicant: SHARP KABUSHIKI KAISHA, Sakai City, Osaka (JP)

(72) Inventors: SHUICHIRO CHIBA, Sakai City, Osaka (JP); YASUO SUGAWARA, Sakai City, Osaka (JP); YOKO KUGE, Sakai City, Osaka (JP)

(21) Appl. No.: 18/721,220

(22) PCT Filed: Dec. 27, 2022
(86) PCT No.: PCT/JP2022/048105

§ 371 Date: Jun. 18, 2024

(30) Foreign Application Priority Data
Feb. 16, 2022 (JP) 2022-022067

(51) Int. Cl. H04W 48/12; H04W 48/18; H04W 84/04

(52) U.S. Cl. CPC H04W 48/12; H04W 48/18; H04W 84/042

(57) ABSTRACT

In 5GS, for URSP rules to be used in a case that a UE is connected to a VPLMN which is a roaming destination network, which one of a set of URSP rules associated with an HPLMN and a set of URSP rules associated with the VPLMN is selected by the UE or the network, delivered by the network to the UE, and used by the UE has not been specified. A selection method and a communication unit are provided that are used by a UE and a network to transmit and/or receive capability information, and/or identification information indicating a request, and/or the like, and to select and deliver, based on the transmitted and/or received identification information, URSP rules associated with the HPLMN and/or URSP rules associated with the VPLMN as URSP rules to be used by the UE connected to the VPLMN.

### TECHNICAL FIELD

The present invention relates to a User Equipment (UE).

### BACKGROUND ART

In the 3rd Generation Partnership Project (3GPP), studies, discussions, and specification formulation work are underway to support new procedures and new functions in a system architecture of a 5G System (5GS), which is a fifth Generation (5G) mobile communication system (see NPLs 1 to 5). For a 5G User Equipment (UE) Policy discussed up to the Release 17 standard, function enhancement is discussed in Release 18.

### CITATION LIST

### Non Patent Literature

NPL 1:3GPP TS 23.501 V 17.3.0(2021-12); 3rd Generation Partnership Project; Technical Specification Group Services and System Aspects; System Architecture for the 5G System; Stage 2 (Release 17)
NPL 2:3GPP TS 23.502 V 17.3.0(2021-12); 3rd Generation Partnership Project; Technical Specification Group Services and System Aspects; Procedures for the 5G System; Stage 2 (Release 17)
NPL 3:3GPP TS 23.503 V 17.3.0(2021-12); 3rd Generation Partnership Project; Technical Specification Group Services and System Aspects; Policy and charging control framework for the 5G System (5GS); Stage 2 (Release 17)
NPL 4:3GPP TS 24.501 V 17.5.0(2021-12); 3rd Generation Partnership Project; Technical Specification Group Core Network and Terminals; Non-Access-Stratum (NAS) protocol for 5G System (5GS); Stage 3 (Release 17)
NPL 5:3GPP TS 24.526 V 17.5.0(2021-12); 3rd Generation Partnership Project; Technical Specification Group Core Network and Terminals; User Equipment (UE) policies for 5G System (5GS); Stage 3 (Release 17)

### SUMMARY OF INVENTION

### Technical Problem

For the 5G System (5GS), a 5G Core Network (5GCN) which is a new core network has been studied for the purpose of providing various services. At present, for the 5GS, a study is under way for extension of the 5G User Equipment (UE) Policy, which has heretofore been discussed.

In the related art, for UE Route Selection Policy (URSP) rules provided as a set of policy information to be used in a case that the UE is connected to a VPLMN, which is a roaming destination network, only URSP rules associated with an HPLMN are supported. On the other hand, in the study of extension of the 5G UE policy, it is under study that URSP rules associated with the VPLMN is further supported, but the following have not been clarified in detail: a method for selecting between the two types of URSP rules, a method for transmission and/or reception of the URSP rules, and procedures and techniques related to handling of storage or management of the URSP rules in a UE or a network apparatus.

The present invention has been made in view of the above circumstances, and an object of the present invention is to provide a method in which a UE connected to a VPLMN and apparatuses of the network select appropriate URSP rules, a procedure in which the UE and each of the apparatuses deliver the selected URSP rules, and information and procedures that are transmitted and/or received between the UE and the network and that are necessary for executing the method and the procedure described above.

### Solution to Problem

An embodiment of the present invention provides a User Equipment (UE) including a transmission and/or reception unit, a storage unit, and a controller, wherein the transmission and/or reception unit transmits a registration request message including first identification information and second identification information to a network in a registration procedure, the first identification information is capability information indicating support of UE Route Selection Policy (URSP) rules associated with a Visited Public Land Mobile Network (VPLMN), the second identification information is information indicating a request for use of the URSP rules associated with the VPLMN, in a procedure for receiving the URSP rules, the procedure being initiated during the registration procedure, the transmission and/or reception unit receives a first set of URSP rules associated with the VPLMN, and the controller stores the first set of URSP rules in the storage unit in association with the VPLMN.

### Advantageous Effects of Invention

An embodiment of the present invention can provide a method in which a UE registered with and connected to a VPLMN that is a roaming destination network selects either URSP rules associated with an HPLMN or URSP rules associated with the VPLMN as URSP rules provided as a set of UE policy information in the connection destination network.

### BRIEF DESCRIPTION OF DRAWINGS

FIG. 1 is a diagram illustrating an overview of a mobile communication system (EPS/5GS).

FIG. 2 is a diagram illustrating a detailed configuration of the mobile communication system (EPS/5GS).

FIG. 3 is a diagram illustrating an apparatus configuration of UE.

FIG. 4 is a diagram illustrating a configuration of an access network apparatus (gNB) in the 5GS.

FIG. 5 is a diagram illustrating a configuration of a core network apparatus (AMF/SMF/UPF/PCF) in the 5GS.

FIG. 6 is a diagram illustrating a registration procedure.

FIG. 7 is a diagram illustrating a UE policy delivery procedure.

### DESCRIPTION OF EMBODIMENTS

Preferred embodiments for carrying out the present invention will be described below with reference to the drawings. Note that an embodiment of a mobile communication system to which the present invention is applied will be described as an example in the present embodiment.

### 1. Overview of System

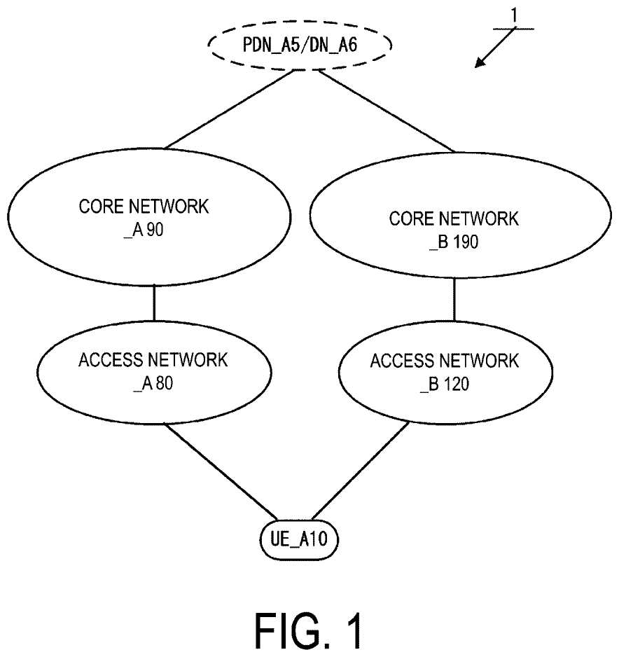

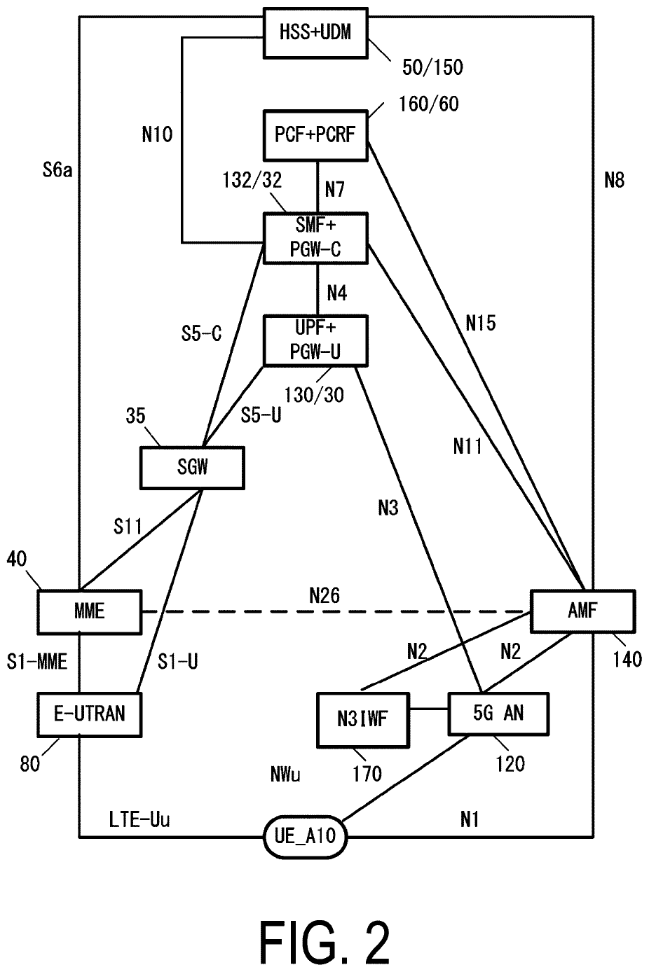

First, FIG. 1 is a diagram illustrating an overview of a mobile communication system 1 used in each embodiment, and FIG. 2 is a diagram illustrating a detailed configuration of the mobile communication system 1.

FIG. 1 illustrates the mobile communication system 1 including UE_A 10, an access network_A 80, a core network_A 90, a Packet Data Network (PDN)_A 5, an access network_B 120, a core network_B 190, and a Data Network (DN)_A 6.

In the following description, the reference numerals of these apparatuses and functions may be omitted, as in UE, an access network_A, a core network_A, a PDN, an access network_B, a core network_B, a DN, and the like.

In addition, FIG. 2 illustrates apparatuses and functions such as the UE_A 10, an E-UTRAN 80, an MME 40, an SGW 35, a PGW-U 30, a PGW-C 32, a PCRF 60, an HSS 50, a 5G AN 120, an AMF 140, a UPF 130, an SMF 132, a PCF 160, a UDM 150, and an N3IWF 170, and interfaces for connecting these apparatuses and functions to each other.

In the following description, the reference numerals of these apparatuses and functions may be omitted as in UE, an E-UTRAN, an MME, an SGW, a PGW-U, a PGW-C, a PCRF, an HSS, a 5G AN, an AMF, a UPF, an SMF, a PCF, a UDM, an N3IWF, and the like.

Note that an Evolved Packet System (EPS) that is a 4G system includes the access network_A and the core network_A and may further include the UE and/or the PDN. A 5G System (5GS) that is a 5G system includes the UE, the access network_B, and the core network_B and may further include the DN.

The UE is an apparatus that can be connected to a network service over 3GPP access (also referred to as a 3GPP access network or a 3GPP AN) and/or non-3GPP access (also referred to as a non-3GPP access network or a non-3GPP AN). The UE may be a terminal apparatus capable of performing radio communication, such as a mobile phone or a smartphone, and may be a terminal apparatus that can be connected to both the EPS and the 5GS. The UE may include a Universal Integrated Circuit Card (UICC) and an Embedded UICC (eUICC). Note that the UE may be referred to as user equipment or a terminal apparatus.

In addition, the access network_A corresponds to an Evolved Universal Terrestrial Radio Access Network (E-UTRAN) and/or a wireless LAN access network. In the E-UTRAN, one or multiple evolved Node-B (eNBs) 45 are deployed. Note that, in the following description, the reference numeral of the eNB 45 may be omitted as in eNB. In addition, in a case that there are multiple eNBs, the eNBs are connected to each other via, for example, an X2 interface. In addition, one or multiple access points are deployed on the wireless LAN access network.

In addition, the access network_B corresponds to a 5G access network (5G AN). The 5G AN includes an NG Radio Access Network (NG-RAN) and/or a non-3GPP access network. One or multiple NR Node-Bs (gNBs) 122 are deployed on the NG-RAN. Note that, in the following description, the reference numeral of the gNB 122 may be omitted, as in eNB. The gNB is a node that provides a New Radio (NR) user plane and control plane to the UE, and is connected to a 5GCN via an NG interface (including an N2 interface or an N3 interface). In other words, the gNB is a base station apparatus newly designed for the 5GS and has functions different from those of the base station apparatus (eNB) used in the EPS that is a 4G system. In addition, in a case that there are multiple gNBs, the gNBs are connected to each other via, for example, an Xn interface.

In addition, a non-3GPP access network may be an untrusted non-3GPP access network or a trusted non-3GPP access network. Here, the untrusted non-3GPP access network may be a non-3GPP access network that does not manage security on the access network, for example, a public wireless LAN. On the other hand, the trusted non-3GPP access network may be an access network defined by the 3GPP and may include a trusted non-3GPP access point (TNAP) and a trusted non-3GPP Gateway function (TNGF).

In addition, in the following description, the E-UTRAN and the NG-RAN may be referred to as 3GPP access. In addition, the wireless LAN access network and the non-3GPP AN may be referred to as non-3GPP access. In addition, nodes deployed on the access network_B may also be collectively referred to as NG-RAN nodes.

In addition, in the following description, the access network_A, and/or the access network_B, and/or an apparatus included in the access network_A, and/or an apparatus included in the access network_B may be referred to as an access network or an access network apparatus.

The core network_A corresponds to an Evolved Packet Core (EPC). In the EPC, for example, a Mobility Management Entity (MME), a Serving Gateway (SGW), a Packet Data Network Gateway (PGW)-U, a PGW-C, a Policy and Charging Rules Function (PCRF), a Home Subscriber Server (HSS), and the like are deployed.

In addition, the core network_B corresponds to a 5G Core Network (5GCN). An Access and Mobility Management Function (AMF), a User Plane Function (UPF), a Session Management Function (SMF), a Policy Control Function (PCF), a Unified Data Management (UDM), and the like are deployed on the 5GCN. Here, the 5GCN may be referred to as a 5GC.

In addition, in the following description, the core network_A, and/or the core network_B, an apparatus included in the core network_A, and/or an apparatus included in the core network_B may be referred to as a core network, a core network apparatus, or an intra-core network apparatus.

The core network (the core network_A and/or the core network_B) may refer to an IP mobile communication network operated by a mobile communication (Mobile Network Operator (MNO)) connecting the access network (the access network_A and/or the access network_B) and the PDN and/or the DN, a core network for a mobile communication operator that operates and manages the mobile communication system 1, or a core network for a virtual mobile communication operator and a virtual mobile communication service provider such as a Mobile Virtual Network Operator (MVNO) and a Mobile Virtual Network Enabler (MVNE).

The core network (the core network_A and/or the core network_B) and the access network (access network_A and/or the access network_B) may differ for each mobile communication operator.

FIG. 1 illustrates a case that the PDN and the DN are the same; however the PDN and the DN may be different. The PDN may be a Data Network (DN) that provides communication services to the UE. Note that the DN may be configured as a packet data service network or may be configured for each service. In addition, the PDN may include a connected communication terminal. Thus, “to be connected to the PDN” may mean “to be connected to a communication terminal and a server apparatus deployed in the PDN”. In addition, “to transmit and/or receive user data to and/or from the PDN” may mean “to transmit and/or receive user data to and/or from a communication terminal and a server apparatus deployed in the PDN”. Note that the PDN may be referred to as a DN, and the DN may be referred to as a PDN.

In addition, in the following, at least some of the access network_A, the core network_A, the PDN, the access network_B, the core network_B, and the DN, and/or one or multiple apparatuses included in these may be referred to as a network or a network apparatus. In other words, the expression that “the network and/or the network apparatus transmits and/or receives a message and/or performs a procedure” means that “at least some of the access network_A, the core network_A, the PDN, the access network_B, the core network_B, and the DN, and/or one or multiple apparatuses included in these transmit and/or receive a message and/or perform a procedure”.

In addition, the UE can be connected to the access network. In addition, the UE can be connected to the core network over the access network. Furthermore, the UE can be connected to the PDN or the DN over the access network and the core network. In other words, the UE can transmit and/or receive (communicate) user data to and/or from the PDN or the DN. In a case that user data is transmitted and/or received, not only Internet Protocol (IP) communication but also non-IP communication may be used.

Here, IP communication refers to data communication using an IP, and data is transmitted and/or received using IP packets. Each IP packet includes an IP header and a payload part. In the payload part, data transmitted and/or received by the apparatuses and functions included in the EPS and the apparatuses and functions included in the 5GS may be included. In addition, non-IP communication refers to data communication performed using no IP, in which data is transmitted and/or received in a form different from the structure of an IP packet. For example, non-IP communication may be data communication implemented through transmission and/or reception of application data to which an IP header is not added, or user data transmitted and/or received by the UE may be transmitted and/or received with another header such as a MAC header and an Ethernet (trade name) frame header added.

In addition, apparatuses which are not illustrated in FIG. 2 may be included in the access network_A, the core network_A, the access network_B, the core network_B, the PDN_A, and the DN_A. For example, the core network_A and/or the core network_B and/or the PDN_A and/or the DN_A may include an Authentication Server Function (AUSF) and an Authentication, authorization, and accounting (AAA) server (AAA-S). The AAA server may be deployed outside the core network.

Here, the AUSF is a core network apparatus provided with an authentication function for 3GPP access and non-3GPP access. Specifically, the AUSF is a network function unit that receives an authentication request for 3GPP access and/or non-3GPP access from the UE and performs an authentication procedure.

Also, the AAA server is an apparatus that is connected directly to the AUSF or indirectly to the AUSF via another network apparatus and has authentication, approval, and billing functions. The AAA server may be a network apparatus within the core network. Note that the AAA server may not be included in the core network_A and/or the core network_B and may be included in a PLMN or an SNPN. In other words, the AAA server may be a core network apparatus or may be an apparatus outside the core network. For example, the AAA server may be a server apparatus within a PLMN or an SNPN managed by a third party.

Note that, although each of the apparatuses and functions is illustrated one by one for simplicity in FIG. 2, multiple similar apparatuses and functions may be included in the mobile communication system 1. Specifically, multiple apparatuses and functions such as multiple pieces of UE_A 10, E-UTRANs 80, MMEs 40, SGWs 35, PGW-Us 30, PGW-Cs 32, PCRFs 60, HSSs 50, 5G ANs 120, AMFs 140, UPFs 130, SMFs 132, PCFs 160, and/or UDMs 150 may be included in the mobile communication system 1.

### 2. Configuration of Each Apparatus

Next, a configuration of each apparatus (the UE, and/or the access network apparatus, and/or the core network apparatus) used in each embodiment will be described with reference to the drawings. Note that each apparatus may be configured as physical hardware, may be configured as logical (virtual) hardware configured in general-purpose hardware, or may be configured as software. At least a part (including all) of the functions of each apparatus may be configured as physical hardware, logical hardware, or software.

Note that each of the storage units (storage unit_A 340, storage unit_A 440, and storage unit_B 540) in the apparatuses and functions appearing below includes, for example, a semiconductor memory, a Solid State Drive (SSD), a Hard Disk Drive (HDD), or the like. In addition, each storage unit can store not only information originally configured at the time of being shipped, but also various pieces of information transmitted and/or received to and/or from apparatuses and functions (for example, the UE, and/or the access network apparatus, and/or the core network apparatus, and/or the PDN, and/or the DN) other than the apparatus and functions of each storage unit. In addition, each storage unit can store identification information, control information, flags, parameters, and the like included in a control message transmitted and/or received in various communication procedures to be described later. In addition, each storage unit may store these pieces of information for each UE. In addition, in a case that each storage unit performs interworking between the 5GS and the EPS, each storage unit can store a control message and user data transmitted and/or received to and/or from the apparatuses and functions included in the 5GS and/or the EPS. In this case, not only data transmitted and/or received over the N26 interface but also data transmitted and/or received without using the N26 interface can be stored.

### 2.1. Apparatus Configuration of UE

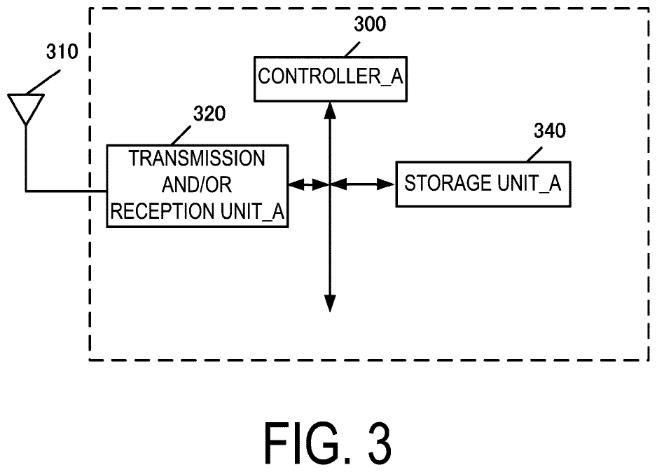

First, an apparatus configuration example of the User Equipment (UE) will be described with reference to FIG. 3. The UE includes a controller_A 300, an antenna 310, a transmission and/or reception unit_A 320, and a storage unit_A 340. The controller_A 300, the transmission and/or reception unit_A 320, and the storage unit_A 340 are connected via a bus. The transmission and/or reception unit_A 320 is connected to the antenna 310.

The controller_A 300 is a function unit that controls overall operations and functions of the UE. The controller_A 300 reads and performs various programs stored in the storage unit_A 340 as necessary, and thereby implements various types of processing in the UE.

The transmission and/or reception unit_A 320 is a function unit that performs radio communication with a base station apparatus (the eNB or the gNB) within the access network via the antenna. In other words, with the use of the transmission and/or reception unit_A 320, the UE can transmit and/or receive user data and/or control information to and/or from the access network apparatus, and/or the core network apparatus, and/or the PDN, and/or the DN.

To provide detailed description with reference to FIG. 2, by using the transmission and/or reception unit_A 320, the UE can communicate with the base station apparatus (eNB) within the E-UTRAN over an LTE-Uu interface. In addition, the UE can communicate with the base station apparatus (gNB) within the 5G AN with the use of the transmission and/or reception unit_A 320. In addition, the UE can transmit and/or receive a Non-Access-Stratum (NAS) message to and/or from the AMF over an N1 interface with the use of the transmission and/or reception unit_A 320. However, the N1 interface is a logical interface, and thus communication between the UE and the AMF is actually performed over the 5G AN.

The storage unit_A 340 is a function unit that stores programs, user data, control information, and the like necessary for each operation of the UE.

### 2.1.1 Apparatus Configuration of gNB

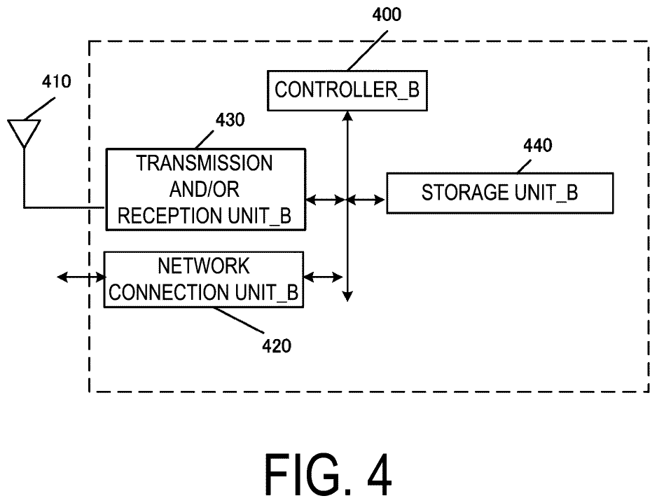

Next, an apparatus configuration example of the gNB will be described with reference to FIG. 4. The gNB includes a controller_B 400, an antenna 410, a network connection unit_B 420, a transmission and/or reception unit_B 430, and a storage unit_B 440. The controller_B 400, the network connection unit_B 420, the transmission and/or reception unit_B 430, and the storage unit_B 440 are connected together via a bus. The transmission and/or reception unit_B 430 is connected to the antenna 410.

The controller_B 400 is a function unit that controls overall operations and functions of the gNB. The controller_B 400 reads and performs various programs stored in the storage unit_B 440 as necessary, and thereby implements various types of processing in the gNB.

The network connection unit_B 420 is a function unit for the gNB to communicate with the AMF and/or the UPF. In other words, with the use of the network connection unit_B 420, the gNB can transmit and/or receive user data and/or control information to and/or from the AMF and/or the UPF.

The transmission and/or reception unit_B 430 is a function unit for wirelessly communicating with the UE via the antenna 410. In other words, with the use of the transmission and/or reception unit_B 430, the gNB can transmit and/or receive user data and/or control information to and/or from the UE.

To provide detailed description with reference to FIG. 2, by using the network connection unit_B 420, the gNB within the 5G AN can communicate with the AMF over the N2 interface and can communicate with the UPF over the N3 interface. In addition, the gNB can communicate with the UE with the use of the transmission and/or reception unit_B 430.

The storage unit_B 440 is a function unit that stores programs, user data, control information, and the like necessary for each operation of the gNB.

### 2.1.2. Apparatus Configuration of AMF

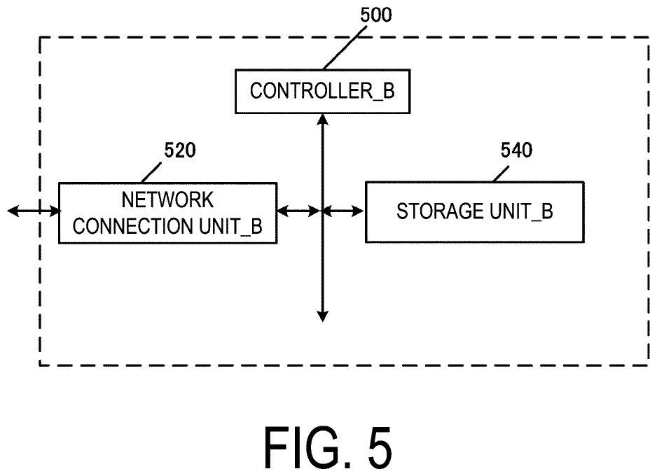

Next, an apparatus configuration example of the AMF will be described with reference to FIG. 5. The AMF includes the controller_B 500, the network connection unit_B 520, and the storage unit_B 540. The controller_B 500, the network connection unit_B 520, and the storage unit_B 540 are connected together via a bus. The AMF may be a node that handles a control plane.

The controller_B 500 is a function unit for controlling the operation and function of the entire AMF. The controller_B 500 implements various processing operations in the AMF by reading out and performing, as necessary, various programs stored in the storage unit_B 540.

The network connection unit_B 520 is a function unit for the AMF to connect to the base station apparatus (gNB) within the 5G AN, and/or the SMF, and/or the PCF, and/or the UDM, and/or an SCEF. In other words, with the use of the network connection unit_B 520, the AMF can transmit and/or receive user data and/or control information to and/or from the base station apparatus (gNB) in the 5G AN, and/or the SMF, and/or the PCF, and/or the UDM, and/or the SCEF. The network connecting unit_B 520 may be a transmission and/or reception unit.

To provide detailed description with reference to FIG. 2, by using a network connection unit_A 520, the AMF within the 5GCN can communicate with the gNB over the N2 interface, can communicate with the UDM over an N8 interface, can communicate with the SMF over an N11 interface, and can communicate with the PCF over an N15 interface. In addition, the AMF can transmit and/or receive a NAS message to and/or from the UE over the N1 interface with the use of the network connection unit_A 520. However, the N1 interface is a logical interface, and thus communication between the UE and the AMF is actually performed over the 5G AN. In addition, in a case that the AMF supports an N26 interface, the AMF can communicate with the MME over the N26 interface with the use of the network connection unit_A 520.

The storage unit_B 540 is a function unit that stores programs, user data, control information, and the like necessary for each operation of the AMF.

Note that the AMF has a function of exchanging a control message with the RAN using the N2 interface, a function of exchanging a NAS message with the UE using the N1 interface, a function of performing encryption and integrity protection of a NAS message, a Registration management (RM) function, a Connection management (CM) function, a Reachability management function, a Mobility management function for the UE or the like, a function of transferring a Session Management (SM) message between the UE and the SMF, an Access Authentication (Access Authorization) function, a security anchor function (Security Anchor Functionality (SEA)), a Security Context Management (SCM) function, a function of supporting the N2 interface for a Non-3GPP Interworking Function (N3IWF), a function of supporting transmission and/or reception of a NAS signal to an/or from the UE via the N3IWF, a function of authenticating the UE connected via the N3IWF, and the like.

In addition, in registration management, an RM state for each piece of UE is managed. The RM state may be synchronized between the UE and the AMF. The RM state includes a deregistered state (RM-DEREGISTERED state) and a registered state (RM-REGISTERED state). In the RM-DEREGISTERED state, because the UE is not registered with the network, the AMF is in a state of being unable to reach the UE, because a UE context in the AMF does not have location information and routing information that are valid for the UE. In addition, in the RM-REGISTERED state, because the UE is registered in the network, the UE can receive a service that requires registration with the network. Note that the RM state may be referred to as a 5GMM state. In this case, the RM-DEREGISTERED state may be referred to as a 5GMM-DEREGISTERED state, and the RM-REGISTERED state may be referred to as a 5GMM-REGISTERED state.

In other words, 5GMM-REGISTERED may be a state in which each apparatus establishes a 5GMM context, or may be a state in which each apparatus establishes a PDU session context. Note that, in a case that each apparatus is in 5GMM-REGISTERED, the UE_A 10 may start transmission and/or reception of user data and a control message, or may respond to paging. Furthermore, in a case that each apparatus is in 5GMM-REGISTERED, the UE_A 10 may perform a registration procedure other than a registration procedure for initial registration, and/or a service request procedure.

In addition, 5GMM-DEREGISTERED may be a state in which each apparatus does not establish the 5GMM context, may be a state in which the location information of the UE_A 10 is not known to the network, or may be a state in which the network is unable to reach the UE_A 10. Note that, in a case that each apparatus is in 5GMM-DEREGISTERED, the UE_A 10 may initiate the registration procedure, or may perform the registration procedure to thereby establish the 5GMM context.

In addition, in connection management, a CM state for each UE is managed. The CM state may be synchronized between the UE and the AMF. The CM state includes a non-connected state (CM-IDLE state) and a connected state (CM-CONNECTED state). In the CM-IDLE state, the UE is in the RM-REGISTERED state, but does not have NAS signaling connection established with the AMF via the N1 interface. In addition, the CM-IDLE state, the UE has neither connection of the N2 interface (N2 connection) nor connection of the N3 interface (N3 connection). On the other hand, in the CM-CONNECTED state, the UE has NAS signaling connection established with the AMF via the N1 interface. In addition, in the CM-CONNECTED state, the UE may have connection of the N2 interface (N2 connection) and/or connection of the N3 interface (N3 connection).

Furthermore, in connection management, management may be performed separately for the CM state in 3GPP access and the CM state in non-3GPP access. In this case, the CM state in 3GPP access may include a non-connected state in 3GPP access (CM-IDLE state over 3GPP access) and a connected state in 3GPP access (CM-CONNECTED state over 3GPP access).

Furthermore, the CM state in non-3GPP access may include a non-connected state in non-3GPP access (CM-IDLE state over non-3GPP access) and a connected state in non-3GPP access (CM-CONNECTED state over non-3GPP access). Note that the non-connected state may be referred to as an idle mode, and a connected state mode may be referred to as a connected mode.

Note that the CM state may be referred to as a 5GMM mode. In this case, the non-connected state may be referred to as a 5GMM non-connected mode (5GMM-IDLE mode), and the connected state may be referred to as a 5GMM connected mode (5GMM-CONNECTED mode). In addition, the non-connected state in 3GPP access may be referred to as a 5GMM non-connected mode in 3GPP access (5GMM-IDLE mode over 3GPP access), and the connected state in 3GPP access may be referred to as a 5GMM connected mode in 3GPP access (5GMM-CONNECTED mode over 3GPP access). In addition, the non-connected state in non-3GPP access may be referred to as a 5GMM non-connected mode in non-3GPP access (5GMM-IDLE mode over non-3GPP access), and the connected state in non-3GPP access may be referred to as a 5GMM connected mode in non-3GPP access (5GMM-CONNECTED mode over non-3GPP access). Note that the 5GMM non-connected mode may be referred to as an idle mode, and the 5GMM connected mode may be referred to as a connected mode.

In addition, one or multiple AMFs may be deployed within the core network_B. In addition, the AMF may be an NF that manages one or multiple Network Slice Instances (NSIs). In addition, the AMF may be a common CP function (Common Control Plane Network Function (CPNF)(CCNF)) shared among multiple NSIs.

Note that, in a case that the UE connects to the 5GS over non-3GPP access, the N3IWF is an apparatus and/or a function deployed between non-3GPP access and the 5GCN.

### 2.1.3. Apparatus Configuration of SMF

Next, an apparatus configuration example of the SMF 132 will be described by using FIG. 5. The SMF includes the controller_B 500, the network connection unit_B 520, and the storage unit_B 540. The controller_B 500, the network connection unit_B 520, and the storage unit_B 540 are connected together via a bus. The SMF may be a node that handles the control plane.

The controller_B 500 is a function unit for controlling the operation and function of the entire SMF. The controller_B 500 implements various processing operations in the SMF by reading out and performing, as necessary, various programs stored in the storage unit_B 540.

The network connection unit_B 520 is a function unit for the SMF to connect to the AMF, and/or the UPF, and/or the PCF, and/or the UDM. In other words, with the use of the network connection unit_B 520, the SMF can transmit and/or receive user data and/or control information to and/or from the AMF, and/or the UPF, and/or the PCF, and/or the UDM. The network connecting unit_B 520 may be a transmission and/or reception unit.

To provide detailed description with reference to FIG. 2, by using of the network connection unit_A 520, the SMF in the 5GCN can communicate with the AMF over the N11 interface, can communicate with the UPF over the N4 interface, can communicate with the PCF over an N7 interface, and can communicate with the UDM over an N10 interface.

The storage unit_B 540 is a function unit that stores programs, user data, control information, and the like necessary for each operation of the SMF.

The SMF has a Session Management function for managing establishment, modification, and release of a PDU session, a function of IP address allocation to the UE and management thereof, a function of selection and control of the UPF, a function of configuring the UPF for routing traffic to an appropriate destination (transmission destination), a function of transmitting and/or receiving an SM part of a NAS message, a function of signaling arrival of downlink data (Downlink Data Notification), a function of providing SM information specific to an AN (for each AN) that is transmitted to the AN through the AMF over the N2 interface, a function of determining a Session and Service Continuity mode (SSC mode) for a session, a roaming function, and the like.

### 2.1.4 Apparatus Configuration of UPF

Next, an apparatus configuration example of the UPF will be described with reference to FIG. 5. The UPF includes a controller_B 700, a network connection unit_B 720, and a storage unit_B 740. The controller_B 700, the network connection unit_B 720, and the storage unit_B 740 are connected via a bus. The UPF may be a node that handles the control plane.

The controller_B 700 is a function unit that controls overall operations and functions of the UPF. The controller_B 700 reads and performs various programs stored in the storage unit_B 740 as necessary, and thereby implements various types of processing in the UPF.

The network connection unit_B 720 is a function unit for the UPF to connect to the base station apparatus (gNB) within the 5G AN, and/or the SMF, and/or the DN. In other words, with the use of the network connection unit_B 720, the UPF can transmit and/or receive user data and/or control information to and/or from the base station apparatus (gNB) within the 5G AN, and/or the SMF, and/or the DN. The network connecting unit_B 520 may be a transmission and/or reception unit.

To provide detailed description with reference to FIG. 2, by using the network connection unit_A 520, the UPF within the 5GCN can communicate with the gNB over the N3 interface, can communicate with the SMF over the N4 interface, can communicate with the DN over an N6 interface, and can communicate with another UPF over an N9 interface.

The storage unit_B 740 is a function unit that stores programs, user data, control information, and the like necessary for each operation of the UPF.

The UPF has a function as an anchor point for intra-RAT mobility or inter-RAT mobility, a function as an external PDU session point to be mutually connected with the DN (that is, a function of transferring user data as a gateway between the DN and the core network_B), a function of routing and transferring packets, an Uplink Classifier (UL CL) function of supporting routing of multiple traffic flows for one DN, a Branching point function of supporting a multi-homed PDU session, a Quality of Service (QOS) processing function for the user plane, a function of verifying uplink traffic, a function of triggering buffering of downlink packets and Downlink Data Notification, and the like.

In addition, the UPF may be a gateway for IP communication and/or non-IP communication. In addition, the UPF may have a function of transferring IP communication, or a function of conversion between non-IP communication and IP communication. Furthermore, multiple deployed gateways may be gateways for connecting the core network_B and a single DN. Note that the UPF may have connectivity with another NF, and may be connected to each apparatus via another NF.

Note that a user plane refers to user data that is transmitted and/or received between the UE and a network. The user plane may be transmitted and/or received using a PDN connection or a PDU session. Furthermore, in a case of the EPS, the user plane may be transmitted and/or received using an LTE-Uu interface, and/or an S1-U interface, and/or an S5 interface, and/or an S8 interface, and/or an SGi interface. Furthermore, in a case of the 5GS, the user plane may be transmitted and/or received over the interface between the UE and the NG RAN, and/or the N3 interface, and/or the N9 interface, and/or the N6 interface. The user plane may be hereinafter referred to as a U-Plane or UP.

In addition, a control plane refers to a control message that is transmitted and/or received in order to perform communication control of the UE or the like. The control plane may be transmitted and/or received using Non-Access-Stratum (NAS) signaling connection between the UE and the MME. In addition, in a case of the EPS, the control plane may be transmitted and/or received using the LTE-Uu interface and an S1-MME interface. Furthermore, in a case of the 5GS, the control plane may be transmitted and/or received using the interface between the UE and the NG RAN and the N2 interface. The control plane may be hereinafter referred to as a control plane, or may be hereinafter referred to as a C-Plane.

Furthermore, the U-Plane (User Plane (UP)) may be a communication path for transmitting and/or receiving user data, and may include multiple bearers. Furthermore, the C-Plane (Control Plane (CP)) may be a communication path for transmitting and/or receiving a control message, and may include multiple bearers.

### 2.1.5. Apparatus Configuration of PCF

Now, an example of the apparatus configuration of the PCF used in each embodiment will be described with reference to FIG. 5. The PCF includes the controller_500, the network connection unit_520, and the storage unit_540. The controller_500, the network connection unit_520, and the storage unit_540 are connected together via a bus.

The controller_500 is a function unit for controlling the operation and function of the entire PCF. Note that the controller_500 may process all of the functions that are not included in the functions of the other function units of the PCF (the network connection unit_520 and the storage unit_540). The controller_500 implements various processing operations in the PCF by reading out and performing, as necessary, various programs stored in the storage unit_540.

The network connection unit_520 is a function unit through which the PCF connects to the AMF and/or the SMF and/or an Application Function (AF). In other words, the PCF can transmit and/or receive control information to and/or from the AMF and/or the SMF and/or the AF by using the network connection unit_520. The network connecting unit_B 520 may be a transmission and/or reception unit.

The PCF can communicate, by using the network connection unit_520, with the AMF over the N15 interface, with the SMF over the N7 interface, and with the AF over the N5 interface (interface between the PCF and the AF).

The storage unit_540 is a function unit for storing programs, user data, control information, and the like necessary for each operation of the UPF.

Note that the PCF includes a function to support a unified policy framework, a function to provide policy rules for a control plane function to force the policy framework, a function to access subscription information, and the like. The PCF also has a function of generating a PCC rule and/or a first PCC rule and/or a second PCC rule and a UE Route Selection Policy (URSP) rule(s) (URSP rule(s)) and the like. These functions may be all controlled by the controller_500.

In this specification, the PCF in the HPLMN is also referred to as a Home PCF (H-PCF), and the PCF in the VPLMN is also referred to as a Visited PCF (V-PCF). Further, for example, the URSP rules generated by the H-PCF are also referred to as URSP rules associated with the HPLMN, and the URSP rules generated by the V-PCF are also referred to as URSP rules associated with the VPLMN.

During roaming, the V-PCF can be connected to the H-PCF via an N24 interface (an interface between PCFs). In other words, the V-PCF can transmit and/or receive control information to and/or from the H-PCF by using the network connection unit 520.

2.1.6. Description of Other Apparatuses and/or Functions

Next, other apparatuses and/or functions will be described.

The PCF has a function such as a function of providing policy rules.

The UDM includes an authentication credential processing function, a user identification processing function, an access authentication function, a registration/mobility management function, a subscriber information management function, and the like.

The PCRF is connected to the PGW and/or the PDN and has a function such as a function of performing QoS management for data delivery. The PCRF performs, for example, QoS management for a communication path between the UE_A 10 and the PDN. The PCRF may also be an apparatus that creates and/or manages a Policy and Charging Control (PCC) rule and/or a routing rule that each apparatus uses in a case of transmitting and/or receiving user data.

The HSS is connected to the MME and/or the SCEF and has a function such as a function of managing subscriber information. The subscriber information of the HSS is referred to, for example, in a case of access control of the MME. The HSS may also be connected to a location management apparatus different from the MME.

### 2.2. Description of Terms in Present Embodiment

Now, highly technical terms and identification information used in procedures which will be used in the embodiments will be described.

A network (NW) refers to at least some of the access network_B, the core network_B, and the DN. One or multiple apparatuses included in at least a part of the access network_B, the core network_B, and the DN may be referred to as a network or a network apparatus. In other words, “a network transmits and/or receives a message and/or performs processing” may mean “an apparatus (a network apparatus and/or a control apparatus) in the network transmits and/or receives the message and/or performs the processing”. Conversely, “an apparatus in a network transmits and/or receives a message and/or performs processing” may mean “the network transmits and/or receives the message and/or performs the processing”.

A network may also refer to a Public Land Mobile Network (PLMN), or refer to a Non-Public Network (NPN), or refer to a Stand-alone Non-Public Network (SNPN). When it is stated that the UE performs a network selection, this may indicate that the UE performs a PLMN selection or may indicate that the UE performs an SNPN selection. Note that in this specification, the access network, the core network, the PLMN, and the SNPN are also each referred to as a network or an NW.

A session management (SM) message (also referred to as a Non-Access-Stratum (NAS) SM message) may be a NAS message used in a procedure for SM, or may be a control message transmitted and/or received between the UE_A 10 and the SMF_A 230 via the AMF_A 240. Furthermore, the SM message may include a PDU session establishment request message, a PDU session establishment accept message, a PDU session reject message (PDU session establishment reject message), a PDU session modification request message, a PDU session modification command message, a PDU session modification completion message (PDU session modification complete), a PDU session modification command reject message, a PDU session modification reject message, a PDU session release request message, a PDU session release reject message, a PDU session release command message, a PDU session release completion message, and the like. The procedure for SM or the SM procedure may include a PDU session establishment procedure, a PDU session modification procedure, and a PDU session release procedure (UE-requested PDU session release procedure). Note that each procedure may be a procedure initiated by the UE or may be a procedure initiated by the NW.

A Mobility management (MM) message (also referred to as a NAS MM message) may be a NAS message used in a procedure for MM, or may be a control message transmitted and/or received between the UE_A 10 and the AMF_A 240. Furthermore, the MM message may include a Registration request message, a Registration accept message, a Registration reject message, a De-registration request message, a De-registration accept message, a configuration update command message, a configuration update completion message, a Service request message, a Service accept message, a Service reject message, a Notification message, a Notification response message, and the like. The procedure for MM or the MM procedure may include a Registration procedure, a De-registration procedure, a Generic UE configuration update procedure, an authentication and authorization procedure, a Service request procedure, a Paging procedure, and a Notification procedure.

A 5G System (5GS) service may be a connection service provided using the core network_B 190. In addition, the 5GS service may be a service different from an EPS service, or may be a service similar to the EPS service.

A non 5GS service may be a service other than the 5GS service and may include an EPS service and/or a non EPS service.

A Packet Data Network (PDN) type indicates a type of PDN connection and includes IPv4, IPv6, IPv4v6, and non-IP. In a case that IPv4 is specified, it indicates that transmission and/or reception of data is performed using IPv4. In a case that IPv6 is specified, it indicates that transmission and/or reception of data is performed using IPv6. In a case that IPv4v6 is specified, it indicates that transmission and/or reception of data is performed using IPv4 or IPv6. In a case that non-IP is specified, it indicates that communication is performed using a communication method other than the IP, not communication using the IP.

There are two Access types, namely a 3GPP access and a non-3GPP access. Here, it is only necessary for information indicating an access type to be configured as an Access type Information Element (IE), and for example, the information may be identification information indicating an access type to be used in signalling or user data transmission and/or reception between the UE and the core network.

Although a Protocol Data Unit/Packet Data Unit (PDU) session can be defined as a relationship between the DN that provides a PDU connectivity service and the UE, the PDU session may be connectivity established between the UE and an external gateway. In the 5GS, the UE establishes a PDU session via the access network_B and the core network_B, and can thereby perform transmission and/or reception of user data to and/or from the DN by using the PDU session. Here, the external gateway may be a UPF, an SCEF, or the like. The UE can perform transmission and/or reception of user data to and/or from an apparatus deployed in the DN, such as an application server, by using the PDU session.

Note that each apparatus (the UE, and/or the access network apparatus, and/or the core network apparatus) may associate one or multiple pieces of identification information with a PDU session for management. Note that these pieces of identification information may include one or multiple of a DNN, a QoS rule, a PDU session type, application identification information, NSI identification information, access network identification information, and an SSC mode, and may further include other pieces of information. In addition, in a case that multiple PDU sessions are established, pieces of identification information associated with the PDU sessions may have the same or different contents.

The Data Network Name (DNN) may be identification information for identifying the core network and/or an external network such as the DN. In addition, the DNN can also be used as information for selecting a gateway such as the PGW_A 30/UPF_A 235 connecting the core network_B 190. In addition, the DNN may correspond to an Access Point Name (APN).

A Protocol Data Unit/Packet Data Unit (PDU) session type indicates a type of PDU session and includes IPv4, IPv6, Ethernet, and Unstructured. In a case that IPv4 is specified, it indicates that transmission and/or reception of data is performed using IPv4. In a case that IPv6 is specified, it indicates that transmission and/or reception of data is performed using IPv6. In a case that Ethernet is specified, it indicates that transmission and/or reception of an Ethernet frame is performed. Alternatively, Ethernet may indicate that communication using the IP is not performed. In a case that Unstructured is specified, it indicates that data is transmitted and/or received to and/or from an application server in the DN or the like by using a Point-to-Point (P2P) tunneling technique. For the P2P tunneling technique, for example, a UDP/IP encapsulation technique may be used. Note that the PDU session type may include the IP, in addition to the above. The IP can be specified in a case that the UE can use both of IPv4 and IPV6.

The Public land mobile network (PLMN) is a communication network that provides mobile radio communication services. The PLMN is a network managed by an operator who is a (mobile) network operator, and the operator can be identified by a PLMN ID. The operator may manage one or multiple PLMNs. Note that in the present document, the PLMN may mean the PLMN ID. A PLMN that matches a Mobile Network Code (MNC) and a Mobile Country Code (MCC) of an International Mobile Subscriber Identity (IMSI) of the UE may be a Home PLMN (HPLMN).

Moreover, the UE may hold, in a Universal Subscriber Identity Module (USIM), an Equivalent HPLMN list for identifying one or multiple Equivalent HPLMNs (E-HPLMNs). The HPLMN and/or a PLMN that is different from the E-HPLMN may be a Visited PLMN (VPLMN, or visiting destination PLMN (VPLMN)). The PLMN that the UE has successfully registered may be a Registered PLMN (RPLMN, registration PLMN). The current PLMN may be a PLMN requested by the UE and/or a PLMN selected by the UE and/or the RPLMN and/or the PLMN allowed by the network and/or the PLMN to which the core network apparatus transmitting and/or receiving messages belongs to. Note that a service provided by the PLMN may be referred to as a PLMN service, and a service provided by an SNPN may be referred to as an SNPN service.

In addition, a network slice (NS) is a logical network that provides specific network capability and network characteristics. The UE and/or the network can support the network slice (NW slice (NS)) in the 5GS. The network slice may be referred to simply as a slice.

In addition, a network slice instance (NSI) includes a set of an instance (entity) of a network function (NF) and necessary resources and forms a network slice to be mapped. Here, the NF is a processing function for a network, and is adopted or defined by the 3GPP. The NSI is an entity of one or multiple NSs configured in the core network_B. In addition, the NSI may include a virtual Network Function (NF) generated using a Network Slice Template (NST).

Here, the NST is associated with a resource request for provision of a requested communication service and capability, and is a logical expression of one or multiple NFs. In other words, the NSI may be a set of multiple NFs on the core network_B 190. The NSI may be a logical network configured for classifying user data to be delivered depending on a service or the like. In the NS, one or multiple NFs may be configured. Each NF configured in the NS may or may not be an apparatus shared with another NS.

The UE and/or the apparatus in the network can be allocated to one or multiple NSs, based on an NSSAI, and/or an S-NSSAI, and/or a UE usage type, and/or subscription information such as one or multiple NSI IDs, and/or an APN. Note that the UE usage type is a parameter value included in subscription information of the UE, which is used for identifying the NSI. The UE usage type may be stored in the HSS. The AMF may select the SMF 132 and the UPF based on the UE usage type.

In addition, Single Network Slice Selection Assistance Information (S-NSSAI) is information for identifying the NS. The S-NSSAI may include only a Slice/Service type (SST), or may include both of an SST and a Slice Differentiator (SD). Here, the SST is information indicating an operation of the NS expected in terms of functions and services. In addition, the SD may be information for interpolating an SST in a case that one NSI is selected out of multiple NSIs indicated by the SST. The S-NSSAI may be information unique to each PLMN or may be standard information common to the PLMNs. In addition, a network may store one or multiple pieces of S-NSSAI in the subscription information of the UE as default S-NSSAI. Note that, in a case that the S-NSSAI is default S-NSSAI and the UE does not transmit, to a network, valid S-NSSAI in a registration request message, the network may provide an NS related to the UE.

In addition, the S-NSSAI transmitted and/or received between the UE and the NW may be referred to as an S-NSSAI Information element (IE). Furthermore, the S-NSSAI IE transmitted and/or received between the UE and the NW may include the S-NSSAI including the SST and/or the SD of the registered PLMN and/or the SST and/or the SD indicating the S-NSSAI of the HPLMN to which the S-NSSAI is mapped. One or multiple pieces of S-NSSAI stored in the UE and/or the NW may include the SST and/or the SD, or include the S-NSSAI including the SST and/or the SD and/or the SST and/or the SD indicating the S-NSSAI of the HPLMN to which the S-NSSAI is mapped.

In addition, the Network Slice Selection Assistance Information (NSSAI) is a set of pieces of the S-NSSAI. Each piece of the S-NSSAI included in the NSSAI is information for assisting the access network or the core network to select an NSI. The UE may store the NSSAI allowed by the network for each PLMN. In addition, the NSSAI may be information used for selecting the AMF. The UE may apply, to the PLMN and the EPLMN, each piece of NSSAI (allowed NSSAI and/or configured NSSAI and/or rejected NSSAI and/or pending NSSAI and/or first NSSAI).

In addition, configured NSSAI is NSSAI fed and stored in the UE. The UE may store the configured NSSAI for each PLMN. The UE may store the configured NSSAI in association with the PLMN. Note that, in the present application, the configured NSSAI associated with the PLMN may be referred to as configured NSSAI with respect to the PLMN, configured NSSAI of the PLMN, configured NSSAI for the PLMN, or configured NSSAI associated with the PLMN. In addition, the UE may store configured NSSAI that is not associated with the PLMN and is valid for all PLMNs, and such configured NSSAI may be defined as “default configured NSSAI”.

The configured NSSAI may be associated with multiple PLMNs, and these multiple PLMNs may be EPLMNs.

The configured NSSAI may be information configured by the network (or PLMN). The S-NSSAI included in the configured NSSAI may be referred to as configured S-NSSAI. The configured S-NSSAI may include S-NSSAI and mapped S-NSSAI. Alternatively, the S-NSSAI of the PLMN may be referred to as “configured S-NSSAI”, and the S-NSSAI in which the configured S-NSSAI is mapped to the HPLMN may be referred to as “mapped S-NSSAI with respect to configured NSSAI for the PLMN”.

In addition, requested NSSAI is NSSAI provided to the network from the UE during the registration procedure. In the registration procedure, the S-NSSAI included in the requested NSSAI transmitted by the UE may be S-NSSAI included in the allowed NSSAI or the configured NSSAI stored in the UE. In the PDU session establishment procedure, the S-NSSAI included in the requested NSSAI transmitted by the UE may be S-NSSAI included in the allowed NSSAI stored in the UE.

The requested NSSAI may be information indicating a network slice requested by the UE. The S-NSSAI included in the requested NSSAI may be referred to as requested S-NSSAI. For example, the requested NSSAI is included, for transmission, in a Non-Access-Stratum (NAS) message transmitted from the UE to the network, such as a registration request message or a PDU session establishment request message, or in a Radio Resource Control (RRC) message including the NAS message.

In addition, the allowed NSSAI is information indicating one or multiple network slices allowed for the UE. In other words, the allowed NSSAI is information identifying a network slice to which the UE is allowed to connect by the network.

The UE and/or the NW may store and manage the allowed NSSAI for each access (the 3GPP access or the non-3GPP access), as information regarding the UE. The UE and/or the NW may further manage the allowed NSSAI in association with the registration area.

Furthermore, the UE and/or the NW may store and manage the allowed NSSAI in association with the PLMN, as information regarding UE. The allowed NSSAI may be associated with multiple PLMNs, and these multiple PLMNs may be EPLMNs.

Note that in the present document, the allowed NSSAI associated with the PLMN and the access type may be referred to as allowed NSSAI with respect to the PLMN and the access type or allowed NSSAI with respect to the access type of the PLMN. The S-NSSAI included in the allowed NSSAI may be referred to as an allowed S-NSSAI. The allowed S-NSSAI may include S-NSSAI and mapped S-NSSAI.

Rejected NSSAI is information indicating one or multiple network slices not allowed for the UE. In other words, the rejected NSSAI is information identifying a network slice to which the UE is not allowed to connect by the network. The rejected NSSAI may be information including one or multiple combinations of S-NSSAI and a reject cause value.

Here, the reject cause value is information indicating why the network rejects the corresponding S-NSSAI. The UE and the network may each appropriately store and manage the rejected NSSAI based on the reject cause value associated with each piece of S-NSSAI.

Furthermore, the rejected NSSAI may be included in the NAS message transmitted from the network to the UE, such as a registration accept message, a configuration update command, or a registration reject message, or in an RRC message including a NAS message. The S-NSSAI included in the rejected NSSAI may be referred to as rejected S-NSSAI.

The rejected NSSAI may be any of the first to third rejected NSSAI, the pending NSSAI, and the first NSSAI, or a combination thereof. The S-NSSAI included in the rejected NSSAI may be referred to as rejected S-NSSAI. The rejected S-NSSAI may include the S-NSSAI and the mapped S-NSSAI.

The UE and/or the NW may store and manage the rejected NSSAI in association with the PLMN, as information regarding the UE. The rejected NSSAI may be associated with multiple PLMNs, and these multiple PLMNs may be EPLMNs.

A tracking area is a single or multiple ranges that can be expressed using location information of the UE_A 10 managed by the core network. The tracking area may include multiple cells. Furthermore, the tracking area may be a range in which a control message such as paging is broadcast, or may be a range in which the UE_A 10 can move without performing a handover procedure. Furthermore, the tracking area may be a routing area, may be a location area, or may be any area similar to these. The tracking area may be hereinafter a TA. The tracking area may be identified by a Tracking Area Identity (TAI) including a Tracking area code (TAC) and a PLMN.

The Registration area is a set of one or multiple TAs allocated to the UE by the AMF. Note that, while moving within one or multiple TAs included in a registration area, the UE_A 10 may be able to move without transmitting and/or receiving a signal for updating the tracking area. In other words, the registration area may be an information group indicating an area in which the UE_A 10 can move without performing a tracking area update procedure. The registration area may be identified by a TAI list configured by one or multiple TAIs.

A TAI included in the TAI list may belong to one PLMN or multiple PLMNs. In a case that multiple TAIs included in the TAI list belong to different PLMNs, the PLMNs may be EPLMNs.

A UE ID is information for identifying the UE. Specifically, the UE ID may be a Subscription Concealed Identifier (SUCI), or a Subscription Permanent Identifier (SUPI), or a Globally Unique Temporary Identifier (GUTI), or an International Mobile Subscriber Identity (IMEI), or an IMEI Software Version (IMEISV), or a Temporary Mobile Subscriber Identity (TMSI), for example. Alternatively, the UE ID may be other information configured by an application or within the network. Moreover, the UE ID may be information for identifying the user.

N1 NAS signalling connection is connection between the UE and the network (AMF) and may be managed and present independently on the 3GPP access and on the non-3GPP access.

A state where the N1 NAS signalling connection is established may be a 5GMM-CONNECTED mode. A state where the N1 NAS signalling connection is not established may be a 5GMM-IDLE mode.

In other words, the state where the NI NAS signalling connection is established on the 3GPP access may be referred to as a state where the UE is in a 5GMM connected mode over 3GPP access (5GMM-CONNECTED mode over 3GPP access), and the state where the NI NAS signalling connection is not established on the 3GPP access may be referred to as a state where the UE is in a 5GMM non-connected mode over 3GPP access (5GMM-IDLE mode over 3GPP access).

Similarly, a state where the N1 NAS signalling connection is established on the non-3GPP access may be referred to as a state where the UE is in a 5GMM connected mode over non-3GPP access (5GMM-CONNECTED mode over non-3GPP access), and a state where the N1 NAS signalling connection is not established on the non-3GPP access may be referred to as a state where the UE is in a 5GMM non-connected mode over non-3GPP access (5GMM-IDLE mode over non-3GPP access).

The Stand-alone Non-Public Network (SNPN) is a type of NPN being a 5GS deployed for non-public use and is an NPN that is operated by an NPN operator and that is not dependent on the NF provided by the PLMN. In other words, the SNPN may be an NPN-dedicated network independent of PLMNs. The SNPN is identified by a combination of a PLMN ID and a Network Identifier (NID). A PLMN ID used for an SNPN ID may be information reserved for a private network, and for example, an MCC included in the PLMN ID may be 999.

The UE that can use the SNPN may support an SNPN access mode. The UE configured to operate in the SNPN access mode may be able to select the SNPN and be registered with the SNPN or need not be able to select the PLMN. The UE configured to operate in the SNPN access mode may be able to perform an SNPN selection procedure or need not be able to perform a PLMN selection procedure. The UE not configured to operate in the SNPN access mode although the UE can use the SNPN (SNPN enabled) need not be able to select the SNPN and be registered with the SNPN or may be able to select the PLMN. The UE not configured to operate in the SNPN access mode need not be able to perform the SNPN selection procedure or may be able to perform the PLMN selection procedure.

The UE operating in the SNPN access mode may be able to select the SNPN via Uu (3GPP access). The UE operating in the SNPN access mode may be able to select the SNPN via Uu or NWu established via a PDU session provided by the PLMN selected via Uu or NWu (non-3GPP access). The UE not operating in the SNPN access mode may be able to select the PLMN via Uu or NWu established via a PDU session provided by the SNPN selected via Uu or NWu (non-3GPP access).

The SNPN may use the functions of the PLMN. Accordingly, in the present document, the PLMN may mean the SNPN.

The Network identifier (NID) is information for identifying the network. An SNPN may be identified by a combination of a PLMN ID and an NID. An NID may be information that is unique within an SNPN or unique information.

A Public network integrated NPN is a network that is implemented using function units of a PLMN. In other words, a Public network integrated NPN is an NPN that is virtually implemented within a PLMN. A Public network integrated NPN is also an NPN that can be created via a PLMN. A Public network integrated NPN may also be implemented using the functionality of a network slice. Specifically, a Public network integrated NPN may be a network that can be implemented using a network slice allocated for an NPN. In this case, the Public network integrated NPN may be identified by S-NSSAI or by a combination of S-NSSAI and a CAG ID.

A Public network integrated NPN may also be implemented using a DN. Specifically, a Public network integrated NPN may be a network that can be implemented using a DN for an NPN. In this case, the Public network integrated NPN may be identified by a DNN or by a combination of a DNN and a CAG ID.

A Closed Access Groups (CAG) ID is information identifying a group of subscribers allowed to connect to one or multiple cells associated with a CAG. A CAG may be a group identified by a CAG ID. A CAG is a group used in a case where a Public network integrated NPN is implemented using a network slice. A CAG may be used to prevent UEs not allowed by an NPN from attempting to access a network slice allocated for the NPN. A CAG ID is information that is unique within a PLMN.

An SNPN-enabled UE is a UE configured to use an SNPN. An SNPN-enabled UE may store at least one piece of information regarding an SNPN. In other words, configuration information of an SNPN-enabled UE may include information indicating that an SNPN is available. An SNPN-enabled UE may also support an SNPN access mode or an SNPN access operation mode. In other words, an SNPN-enabled UE may operate in the SNPN access mode or the SNPN access operation mode.

The SNPN access mode is a mode in which the UE selects only the SNPN. More specifically, the UE in the SNPN access mode may be a mode in which the UE performs a procedure, processing, or the like for registering with and connecting to the SNPN. Further, in a case of performing an SNPN selection or ON-SNPN selection as a network selection, or in a case of performing a normal registration procedure with the SNPN, or in a case of performing a registration procedure for onboarding, or in a case of performing a procedure for remote provisioning, the UE needs to operate in the SNPN access mode. Here, a UE operating in the SNPN access mode may be referred to as a UE in the SNPN access mode. A UE in the SNPN access mode may also be an SNPN-enabled UE.

The SNPN access operation mode is the SNPN access mode or a mode of connecting to an SNPN via non-3GPP access. Here, “non-3GPP access” in an SNPN may refer to a case where a UE is connected to an SNPN via a PLMN. The UE may also operate in the SNPN access operation mode in a case where the UE operates in the SNPN access mode. The UE may also not operate in the SNPN access operation mode in a case where the UE does not operate in the SNPN access mode. A UE in the SNPN access mode may also be a UE in the SNPN access operation mode.

A UE operating in the SNPN access mode or the SNPN access operation mode may perform an SNPN selection process. A UE not operating in the SNPN access mode or the SNPN access operation mode may not perform an SNPN selection process. An SNPN selection process may have an automatic SNPN selection mode and a manual SNPN selection mode. An SNPN selection procedure may be performed without registration. In other words, an SNPN selection procedure may be performed in a case where a UE has not completed registration with the network.

A UE not operating in an SNPN access mode or an SNPN access operation mode may perform a PLMN selection process. A UE operating in the SNPN access mode or the SNPN access operation mode may not perform a PLMN selection process. A PLMN selection procedure may be performed without registration. In other words, a PLMN selection procedure may be performed in a case where a UE has not completed registration with the network. A PLMN selection process may have an automatic PLMN selection mode and a manual PLMN selection mode.

The UE in the SNPN access operation mode may mean the UE in the SNPN access mode or the UE accessing an SNPN via non-3GPP. In other words, even the UE not in the SNPN access mode may be the UE in the SNPN access operation mode in a case that the UE connects to the SNPN via non-3GPP.

A Non-Public Network (NPN) is a private network that is not intended for general use but is used by specific users for specific purposes such as the private use of a company or the like. There are two types of NPNs: a Stand-alone Non-Public Network (SNPN) and a Public network integrated NPN. When an NPN is described below, this may mean both an SNPN and a Public network integrated NPN.

A UE operating in the SNPN access mode or the SNPN access operation mode may perform an Onboarding Network selection process. In other words, a UE may operate in the SNPN access mode or the SNPN access operation mode in a case where an Onboarding Network selection process is performed.

The UE Route Selection Policy (URSP) may be a policy used by the UE to determine whether a detected application is associated with an established PDU session, is offloaded to a non-3GPP access outside the PDU session, is routed via a Proximity based Services (ProSe) layer 3 UE-to-Network relay outside the PDU session, or may trigger establishment of a new PDU session. Note that the URSP may be a policy included in the UE policy information provided by the PCF.

The UE Route Selection Policy rules (URSP rules) may include a list of one or more USRP rules (UE Route Selection Policy (URSP) Rule). Each URSP rule may include Rule Precedence and/or a Traffic descriptor and/or a List of Route Selection Descriptors. Here, the traffic descriptor may be used to indicate a matching condition determined by the UE based on the URSP.

Here, the rule precedence in the URSP rule indicates the order of the URSP rules forced in the UE. In a case of receiving the URSP rules, i.e., receiving one or more URSP rules, the UE may reference the rule precedence of each URSP rule, and apply the URSP rules in order of decreasing precedence.

The traffic descriptor in the URSP rules indicates when to apply the URSP rule. Here, the traffic descriptor in the URSP rule includes Application descriptors, and/or IP descriptors, and/or Domain descriptors, and/or Non-IP descriptors, and/or a Data Network Name (DNN), and/or Connection Capabilities.

The application descriptors in the traffic descriptor in the URSP rule may include an ID of an OS and an application ID of the OS.

The IP descriptors in the traffic descriptor in the URSP rule indicate information for identifying the destination of IP traffic, and may include, for example, an IP address, an IPV6 network prefix, a port number, a protocol number, and the like.

The Domain descriptors in the traffic descriptor in the URSP rule may indicate the Fully Qualified Domain Name (FQDN) of the transmission destination.

The non-IP descriptors in the traffic descriptor in the URSP rule may indicate information for identifying the destinations of non-IP traffic (e.g., ethernet traffic or unstructured traffic).

The DNN in the traffic descriptor in the URSP rule may be information related to the DNN provided by the application.

The connection capabilities in the traffic descriptor in the URSP rule may indicate information provided by the application of the UE in a case that the UE requests connection to the network by using a certain capability.

The list of route selection descriptors in the URSP rule may include one or more Route Selection Descriptors. Each route selection descriptor may include Route Selection Descriptor Precedence and/or a route selection component (Route selection components).

The rule selection descriptor precedence indicates the order of the route selection descriptors for application. In a case of receiving the list of route selection descriptors, i.e., in a case of receiving one or more route selection descriptors, the UE may refer to the rule selection descriptor precedence in each route selection descriptor, and apply the route selection descriptors in descending order of precedence.

The route selection configuration may include an SSC Mode Selection, and/or a Network Slice Selection, and/or a DNN Selection, and/or a PDU Session Type Selection, and/or a Non-Seamless Offload indication, and/or an Access Type preference.

Here, the SSC mode selection may indicate that the traffic of the application is routed via a PDU session in an indicated SSC mode.

The network slice selection may indicate that the traffic of the application is routed by using a PDU session that supports one or more pieces of S-NSSAI indicated.

The DNN selection may indicate that the traffic of the application is routed by using a PDU session that supports one or more DNNs indicated.

The PDU session type selection may indicate that the traffic of the application is routed by using a PDU session that supports the indicated PDU session type.

The non-seamless offload indication may indicate that the traffic of the application is offloaded to the non-3GPP access.

The access type preference may indicate the access type of the access with which the PDU session is established in a case that the UE needs to establish the PDU session. Here, the access type may indicate 3GPP, or non-3GPP or Multi Access, or eATSSS. Here, the eATSSS may be designated in a case that a PDU session using the eATSSS function is established, and 3GPP access or non-3GPP access may be indicated that corresponds to an SA PDU session to be established.

The URSP rules may also include URSP rules associated with the HPLMN and URSP rules associated with the VPLMN. Here, the URSP rules associated with the HPLMN may be URSP rules generated by the PCF of the HPLMN. The URSP rules associated with the VPLMN may be URSP rules generated by the V-PCF, which is the PCF of the VPLMN. The URSP rules may be associated with the PLMN and transmitted and/or received between the UE and the network. More specifically, for example, the information element storing the URSP rules may include the MCC and MNC of the PLMN associated with each URSP rule. Further, the URSP rules may be stored in the UE or each apparatus of the network in association with the PLMN.

Further, the URSP rules used by the UE may be generated or determined based on the network to which the UE is connected and/or the policy of the network to which the UE is connected and/or the capabilities of the UE and/or the capabilities of the network, the subscription of the UE, and the like. More specifically, for example, the URSP rules associated with the HPLMN may be used in a case that the UE is registered with or connected to the HPLMN. For example, in a case that the UE is registered with or connected to the roaming destination VPLMN, the URSP rules associated with the HPLMN may be used or the URSP rules associated with the VPLMN may be used.

The Subscription Permanent Identifier (SUPI) is globally unique permanent identification information of a 5G subscriber assigned to each subscriber in the 5G system. Possible types of the SUPI may include an IMSI, or a Network Specific Identifier (NSI), or a Global Line Identifier (GLI), or a Global Cable Identifier (GCI).

The Subscription Concealed Identifier (SUCI) is a privacy-protected identifier including a concealed SUPI.

### 2.3. Description of Identification Information in Present Embodiment

Next, identification information transmitted and/or received and stored and managed by apparatuses will be described in the present embodiment.

First identification information in the present embodiment is capability information (capability) indicating that the UE supports the use of the URSP rules associated with the VPLMN. Here, a UE supporting the URSP rules associated with the VPLMN may indicate that the UE can use the URSP rules generated by the VPLMN or the PCF in the VPLMN in a case of being connected to and/or registered with the VPLMN.

Here, a UE supporting the use of the URSP rules associated with the VPLMN may indicate that the UE supports the URSP rules associated with the VPLMN.

The UE supporting the URSP rules associated with the VPLMN may indicate that the UE can store the URSP rules generated/transmitted by the VPLMN or the PCF in the VPLMN, or may indicate that the UE can receive, from the VPLMN or the PCF in the VPLMN, the URSP rules generated by the VPLMN or the PCF in the VPLMN.

The UE supporting the URSP rules associated with the VPLMN may indicate that the UE can store both the URSP rules generated/transmitted by the VPLMN or the PCF in the VPLMN and the URSP rules generated/transmitted by the HPLMN or the PCF in the HPLMN.

Note that the URSP rules delivered by the VPLMN may be URSP rules generated by the VPLMN or the PCF of the VPLMN, or may be URSP rules generated and/or delivered by the Visited PCF (V-PCF). The URSP rules may include URSP rules associated with the VPLMN and URSP rules associated with the HPLMN.

Here, the URSP rules associated with the HPLMN may be URSP rules generated by the HPLMN or the PCF of the HPLMN. Further, for example, in a case that the UE is connected to the VPLMN, the URSP rules may be delivered from the Home PCF (H-PCF) to the UE via the V-PCF.

Here, for example, by including the first identification information in the registration request message, the UE may indicate that the UE supports the use of URSP rules associated with the VPLMN. Alternatively, for example, by not including the first identification information in the registration request message, the UE may indicate that the UE does not support the use of the URSP rules associated with the VPLMN.

The first identification information may be capability information (capability) indicating whether the UE supports the use of the URSP rules associated with the VPLMN. In this case, for example, the first identification information may indicate that the UE does not support the use of the URSP rules associated with the VPLMN. The first identification information may be 5GMM capability IE and may be included in a 5GMM capability IE.

The first identification information may be information indicating that the UE supports the URSP rules associated with the VPLMN, or supports the URSP rules associated with the HPLMN, or supports both sets of URSP rules.

Note that in this specification, unless otherwise stated, the first identification information refers to capability information indicating that the UE supports the use of the URSP rules associated with the VPLMN.

The first identification information may include the contents of the second identification information described above. More specifically, for example, by transmitting the first identification information to the network, the UE may indicate that the UE supports the use of the URSP rules associated with the VPLMN and requests the use of the URSP rules associated with the VPLMN. In other words, by transmitting the first identification information to the network or each apparatus of the network, the UE may indicate that the UE requests the use of the URSP rules associated with the VPLMN.

The second identification information in the present embodiment is identification information indicating that the UE requests the URSP rules associated with the VPLMN.

For example, by transmitting, to the network or each apparatus of the network, the second identification information included in a message, a UE attempting to register with and/or connect to the VPLMN may indicate a request to use the URSP rules associated with the VPLMN as the URSP rules.

The second identification information may include the contents of the first identification information described above. More specifically, for example, by transmitting the second identification information to the network, the UE may indicate that the UE supports the use of the URSP rules associated with the VPLMN and requests the use of the URSP rules associated with the VPLMN. In other words, by transmitting the second identification information to the network or each apparatus of the network, the UE may indicate that the UE supports the use of URSP rules associated with the VPLMN.

Alternatively, the contents of the second identification information may be included in the first identification information described above. More specifically, for example, by transmitting the first identification information to the network, the UE may indicate that the UE supports the use of the URSP rules associated with the VPLMN and requests the use of the URSP rules associated with the VPLMN. In other words, by transmitting the first identification information to the network or each apparatus of the network, the UE may indicate that the UE requests the use of the URSP rules associated with the VPLMN.

Note that the second identification information may be information indicating a preference of the UE related to the URSP rules associated with the VPLMN. More specifically, by using the second identification information to indicate the preference related to the URSP rules associated with the VPLMN, the UE may indicate a request for the URSP rules associated with the VPLMN.

Third identification information in the present embodiment may be capability information indicating that the VPLMN with and/or to which the UE is registered and/or connected supports delivery of the URSP rules associated with the VPLMN. Here, the third identification information may be identification information to be included in a response message in a case that the network or each apparatus receives, from the UE, a request message including the first identification information and accepts the first identification information.

Further, for example, by transmitting the third identification information to the UE, the network or each apparatus may indicate that the network or the apparatus has accepted the request of the UE or the use of the URSP rules associated with the VPLMN. In other words, in a case of receiving the third identification information, the UE may recognize that the network or each apparatus has accepted the use of the URSP rules associated with the VPLMN.

Note that the behavior of the UE, the core network, or each apparatus related to the transmission and/or reception of the third identification information is not limited to the behavior described above, and details including other behaviors will be described below.

The fourth identification information in the present embodiment may indicate that the VPLMN with and/or to which the UE is registered and/or connected delivers the URSP rules associated with the VPLMN. Here, the fourth identification information may be identification information to be included in a response message in a case that the network or each apparatus receives, from the UE, a message including the first identification information and/or the second identification information and accepts one or more pieces of identification information out of the first identification information and/or the second identification information.

Note that the behaviors of the UE and the core network or each apparatus thereof related to the transmission and/or reception of the fourth identification information is not limited to the behaviors described above, and details including other behaviors will be described below.

### 3. Embodiments in Present Invention

### 3.1 Description of Procedures or Processing Used in Each Embodiment

Next, procedures used in each embodiment will be described. Note that the procedure or processing used in each embodiment may include a registration procedure and a UE policy delivery procedure.

Here, the registration procedure may be a procedure used in a case that the UE is connected to a VPLMN which is a roaming destination network, or may be an initial registration procedure.

The UE policy delivery procedure may include a UE policy delivery procedure performed during the registration procedure and a UE policy delivery procedure performed at any timing as necessary after completion of the registration procedure.

Note that, in each embodiment, a case that each of the HSS and the UDM, the PCF and the PCRF, the SMF and the PGW-C, and the UPF and the PGW-U is configured as a single apparatus (that is, the same physical hardware, or the same logical hardware, or the same software) as illustrated in FIG. 2 will be described as an example. However, the details described in the present embodiment can also be applied to a case that each of the combinations is configured as different apparatuses (that is, different pieces of physical hardware, or different pieces of logical hardware, or different pieces of software). For example, between the apparatuses/functions, data may be directly transmitted and/or received, data may be transmitted and/or received via an N26 interface between the AMF and the MME, or data may be transmitted and/or received via the UE.

Hereinafter, each of the procedures will be described.

### 3.1.1 Registration Procedure

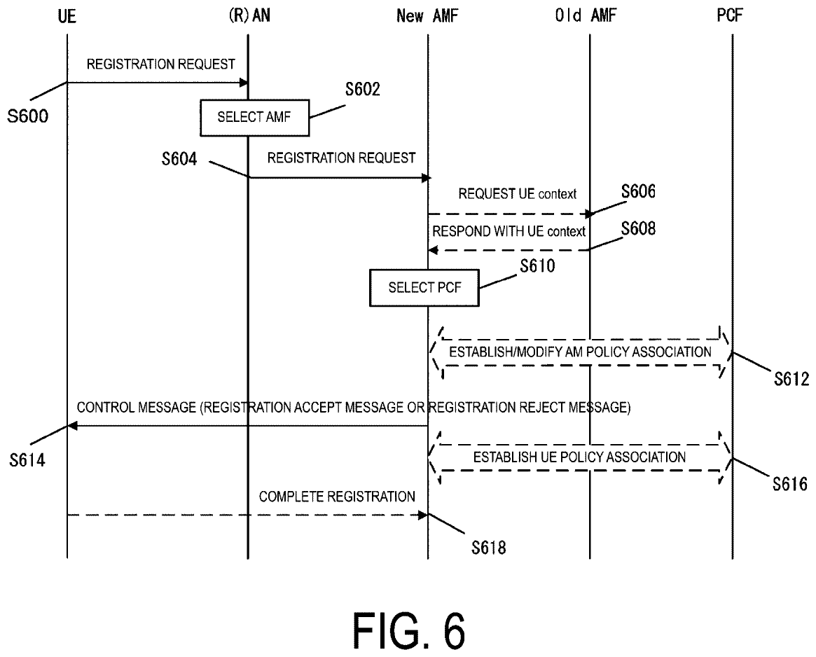

The Registration procedure will be described with reference to FIG. 6. Note that the registration procedure in the present invention may be a registration procedure for registering with the VPLMN which is the roaming destination network of the UE. Further, in the description below, each apparatus of the network may be an apparatus in the VPLMN. Hereinafter, the registration procedure is also referred to as the present procedure.

The present procedure in the present invention may be an initial registration procedure unless otherwise specified. Alternatively, the present procedure may be a mobility and periodic registration update procedure.

The registration procedure is a procedure that is initiated by the UE for registration with the access network_B and/or the core network_B and/or the DN and/or the PLMN. In a case that the UE is in a state of not being registered with the network, for example, the UE can perform the present procedure at any timing, for example, a power input time. In other words, the UE can initiate the present procedure at any timing as long as the UE is in the deregistered state (5GMM-DEREGISTERED state). In addition, each apparatus (in particular, the UE and the AMF) can transition to the registered state (5GMM-REGISTEDED state), based on completion of the registration procedure. Note that each registered state may be managed by each apparatus for each access. Specifically, each apparatus may independently manage the registration state (registered state or deregistered state) for 3GPP access and the registration state for non-3GPP access.

In addition, the registration procedure may be a procedure for updating position registration information of the UE on the network, and/or periodically signaling the state of the UE from the UE to the network, and/or updating a specific parameter related to the UE on the network.

The UE may initiate the registration procedure at the time of having mobility across tracking areas (TAs). In other words, the UE may initiate the registration procedure in a case that the UE moves to a TA that is different from the TA indicated by a TA list (TAI list or registration area) held by the UE. Furthermore, the UE may initiate the present procedure in a case that the running back-off timer or any other timer expires. In addition, the UE may initiate the registration procedure in a case that a context of each apparatus needs to be updated due to disconnection and/or invalidation of a PDU session. Furthermore, in a case that there is a change in capability information and/or a preference, related to PDU session establishment of the UE, the UE may initiate the registration procedure. In addition, the UE may periodically initiate the registration procedure. Furthermore, the UE may initiate the registration procedure based on completion of the UE configuration update procedure, or based on completion of the registration procedure, or based on completion of the PDU session establishment procedure, or based on completion of the PDU session management procedure, or based on information received from the network in each procedure, or based on expiry or stop of the back-off timer. Note that the UE is not limited to this configuration, and can perform the registration procedure at any timing.

Note that the above-described procedure for the UE to transition from a state of not being registered with the network to a state of being registered with the network may be considered to be an initial registration procedure or a registration procedure for initial registration, and the registration procedure performed for the UE being registered with the network may be considered to be a registration procedure for mobility and periodic registration update or a mobility and periodic registration procedure.

Note that the UE may perform the network selection described above and select and determine the PLMN or SNPN or ON-SNPN requested by the UE before the registration procedure or in an initial state of the registration procedure.

A new AMF 141 in FIG. 6 indicates an AMF with which the UE_A 10 is registered through the present procedure, and an old AMF 142 means an AMF with which the UE has been registered in a procedure before the present procedure. In a case that no change in AMF occurs in the present procedure, an interface between the old AMF 142 and the new AMF 141 and a procedure between the old AMF 142 and the new AMF 141 do not occur, and the new AMF 141 may be the same apparatus as the old AMF 142. Note that in the present document, description of AMF may mean the new AMF 141, may mean the old AMF 142, or may mean both of them. The new AMF 141 and the old AMF 142 may be AMFs 140.

First, the UE_A 10 initiates the registration procedure by transmitting the Registration request message to the new AMF 141 (S600), (S602), and (S604). Specifically, the UE transmits an RRC message including the registration request message to the 5G AN 120 (or the gNB) (S600). Moreover, the registration request message is a NAS message transmitted and/or received over the N1 interface. In addition, the RRC message may be a control message transmitted and/or received between the UE and the 5G AN 120 (or the gNB). In addition, the NAS message is processed in the NAS layer, and the RRC message is processed in the RRC layer. Note that the NAS layer is a layer higher than the RRC layer.

Here, the UE_A 10 may include the first identification information and/or the second identification information in the NAS message and/or the RRC message including the registration request message and/or the registration request, and transmit the NAS message and/or the RRC message. Note that the first identification information and the second identification information may be configured as information obtained by combining the first identification information with the second identification information.

Here, in a case that the UE transmits the registration request message including the first identification information and/or the second identification information, the UE may be a UE supporting the use of the URSP rules associated with the VPLMN. Further, a UE supporting the use of the URSP rules associated with the VPLMN may support the use of the URSP rules associated with the HPLMN in addition to the support of use of the URSP rules associated with the PLMN.

In a case of supporting the URSP rules associated with the VPLMN, the UE may transmit the first identification information indicating that the URSP rules associated with the VPLMN are supported. In other words, the UE may transmit the 5GMM capability IE set with the first identification information indicating that the UE supports the URSP rules associated with the PLMN.

In a case of supporting storage of both the URSP rules associated with the VPLMN and the URSP rules associated with the HPLMN, the UE may transmit the first identification information indicating that the UE supports the use of the URSP rules associated with the VPLMN or supports the URSP rules associated with the HPLMN.

Further, the UE may transmit the second identification information as information indicating a preference of the UE related to the URSP rules associated with the VPLMN. More specifically, by using the second identification information to indicate the preference related to the URSP rules associated with the VPLMN, the UE may indicate a request for the URSP rules associated with the VPLMN.

By transmitting the second identification information, the UE may further indicate that the UE supports the use of URSP rules associated with the VPLMN. More specifically, by transmitting only the second identification information without transmitting the first identification information, the UE may indicate the support of use of the URSP rules associated with the VPLMN.

Alternatively, conversely, by transmitting only the first identification information without transmitting the second identification information, the UE may indicate a request to use the URSP rules associated with the VPLMN.

In a case of not supporting the URSP rules associated with the VPLMN, the UE may support the URSP rules associated with the HPLMN, and in that case, the UE may transmit the first identification information indicating that the UE does not support the URSP rules associated with the VPLMN, or may transmit the first identification information indicating that the UE supports the URSP rules associated with the HPLMN, or the UE need not transmit the first identification information indicating that the UE supports the URSP rules associated with the PLMN.

Furthermore, the UE_A 10 may include identification information indicating the type of the present procedure in the registration request message and/or the RRC message and transmit the identification information. Here, the identification information indicating the type of the present procedure may be a 5GS registration type IE, and may be information indicating that the present procedure is the registration procedure performed for initial registration, or for update of the subscription information associated with movement, or for periodic update of the subscription information, or for registration at the time of emergency.

Here, the identification information indicating the type of the present procedure being the 5GS registration type IE may mean that the identification information indicating the type of the present procedure is included and set in the 5GS registration type IE.

The UE_A 10 may include capability information of the UE in the registration request message or may include the first identification information therein as capability information of the UE in order to notify the network of the function that the UE_A 10 supports. Here, the UE capability information may be 5GMM capability in the 5GS.

The UE_A 10 may include and transmit the first identification information in a control message that is different from the above messages, for example, a control message of a lower layer than the RRC layer (a MAC layer, an RLC layer, or a PDCP layer, for example). Note that the UE_A 10 may indicate that the UE_A 10 supports each function, may indicate a request of the UE, or may indicate both, by transmitting these pieces of identification information. Note that information indicating support of each function and information indicating a request for use of each function may be transmitted and/or received as the same piece of identification information, or may be transmitted and/or received as different pieces of identification information.

Note that the UE_A 10 may select or determine whether to transmit the first identification information to the network based on the UE capability information and/or the UE policy and/or the UE state and/or the user subscription information and/or a context stored in the UE and/or the like.

Furthermore, the UE_A 10 may indicate a request for capability information of the network indicating that the network supports the function corresponding to the first identification information, by including and transmitting the first identification information in the registration request message.

The UE_A 10 may include information other than the first identification information and/or the second identification information in the registration request message and/or the NAS message or the RRC message including the registration request message. For example, the UE may include, in the registration request message, a UE STATE INDICATION message generated by the UE.

Here, the UE state indication message may be included in a Payload container information element in the registration request message, and further, an information element (Payload container type information element) indicating the type of the payload container may be a UE policy container. Further, the UE may configure the PTI information element (PTI IE) with a currently unused Procedure Transaction Identity (PTI) allocated by the UE, and includes the PTI information element in the UE state indication message.

Further, a UE not operating in the SNPN access operation mode may include, in a UE policy section identifier list information element (IE) (UPSI list information element) in the UE state indication message, one or more UPSIs of the UE policy section identified by a PLMN ID part indicating HPLMNs available to the UE or a selected PLMN. Here, the selected PLMN may be the VPLMN, or may be the EPLMN. For example, the PLMN ID part may include a Mobile Country Code (MCC) and a Mobile Network Code (MNC).

Further, a UE operating in the SNPN access operation mode may include one or more UPSIs of the UE policy section identified by the UPSI. Here, the UPSI may include the Mobile Country Code (MCC) and the Mobile Network Code (MNC) indicated by the PLMN ID part of the selected SNPN, or may include the NID of the selected SNPN.

Note that the UE state indication message may be a message for a UE-initiated UE state indication procedure, and may also be a message transmitted from the UE to the PCF. Here, the UE-initiated UE state indication procedure may be a procedure performed during the registration procedure, and the UE state indication message may be transmitted to the (V-) PCF via the (V-) AMF during the registration procedure.

Here, the purpose of the UE-initiated UE state indication procedure may be to deliver the UPSI(s) of the UE policy section(s), or to indicate whether the UE supports an Access Network Discovery and Selection Policy (ANDSP), or to deliver one or multiple OS IDs of the UE. Here, the UPSI(s) delivered by the UE in the UE-initiated UE state indication procedure may be one or more UPSIs of the UE policy section identified by the UPSI with the PLMN ID part indicating the HPLMN or the selected PLMN. The selected PLMN may be the VPLMN, or may be the EPLMN. For example, the PLMN ID part may include a Mobile Country Code (MCC) and a Mobile Network Code (MNC).

Here, the AMF identification information included in the registration request message and/or the RRC message including the registration request message may be information for identifying the AMF or a set of AMFs, for example, a 5G S-Temporary Mobile Subscription Identifier (5G S-TMSI) or a Globally Unique AMF Identifier (GUAMI).

In addition, the UE_A 10 may include and transmit an SM message (for example, a PDU session establishment request message) in the registration request message, or may transmit an SM message (for example, a PDU session establishment request message) together with the registration request message to thereby initiate a PDU session establishment procedure during the registration procedure.

In a case that the 5G AN 120 (or the gNB) receives an RRC message including the registration request message, then the 5G AN 120 (or the gNB) selects an AMF to transfer the registration request message (S602). Note that the 5G AN 120 (or the gNB) can select an AMF based on one or multiple pieces of identification information included in the registration request message and/or the RRC message including the registration request message. Specifically, the 5G AN (or the gNB) may select the new AMF 141 as a transmission destination of the registration request message based on the first identification information.

For example, the 5G AN 120 (or the gNB) may select an AMF supporting the function corresponding to the capability information indicated by the first identification information based on the first identification information. To be specific, the 5G AN (or gNB) may select an AMF corresponding to the capability information of the UE indicated by the first identification information, the AMF being capable of delivering the URSP rules associated with the VPLMN or connecting to or communicating with the PCF that delivers the URSP rules associated with the VPLMN.

Note that the method of selecting an AMF is not limited to thereto and the 5G AN (or the gNB) may select an AMF based on other conditions. The 5G AN (or the gNB) extracts the registration request message from the received RRC message and transfers the registration request message to the selected new AMF (S604). Note that in a case that the first identification information and/or the second identification information is not included in the registration request message and is included in the RRC message, the identification information included in the RRC message may be transmitted to the selected AMF (new AMF 141) along with the registration request message (S604).

In a case that the registration request message has been received, the new AMF 141 can perform first condition fulfillment determination. The first condition fulfillment determination is performed by the network (or the new AMF 141) to determine whether to accept the request from the UE. In a case that the first condition fulfillment determination is true, the new AMF 141 performs the procedure from S606 to S618. On the other hand, in a case that the first condition fulfillment determination is false, the new AMF 141 may skip the procedure from S606 to S602 and perform the procedure of S614.

Alternatively, the new AMF 141 may perform the first condition fulfillment determination after requesting a UE context from the old AMF 142 and then receiving the UE context from the old AMF 142 (S606 and S608). In that case, the new AMF 141 may perform S610 to S618 in a case that the first condition fulfillment determination is true. On the other hand, in a case that the first condition fulfillment determination is false, the new AMF 141 may perform S614.

Note that here, in a case that the first condition fulfillment determination is true, the control message transmitted and received in S614 may be a Registration accept message, and in a case that the first condition fulfillment determination is false, the control message transmitted and received in S614 may be a Registration reject message.

Note that the first condition fulfillment determination may be performed based on reception of the registration request message, and/or each piece of identification information included in the registration request message, and/or subscriber information, and/or capability information of the network, and/or the operator policy, and/or a state of the network, and/or subscription information of the user, and/or a context stored in the AMF, and/or the like.

For example, the first condition fulfillment determination may be true in a case that the network allows the request from the UE, and the first condition fulfillment determination may be false in a case that the network does not allow the request from the UE. In addition, in a case that a network with which the UE is to be registered and/or an apparatus in the network supports the function requested by the UE, the first condition fulfillment determination may be true, whereas in a case that the network and/or the apparatus does not support the function requested by the UE, the first condition fulfillment determination may be false. Furthermore, in a case that the transmitted and/or received identification information is allowed, the first condition fulfillment determination may be true, whereas in a case that the transmitted and/or received identification information is not allowed, the first condition fulfillment determination may be false.

The new AMF 141 performs the procedure of S606 and S608 in a case that the AMF indicated by the AMF identification information included in the message received by the new AMF 141 from the UE is the old AMF 142, and does not perform the procedure of S606 and S608 in a case that the AMF indicated by the AMF identification information included in the message received by the new AMF 141 from the UE_A 10 is the new AMF 141. In other words, the procedure of S606 and S608 is performed in a case that a change occurs in the AMF (AMF change) due to the present procedure, and the procedure of S606 and S608 is skipped in a case that no change occurs in the AMF.

A UE context transfer procedure will be described (S606 and S608).

First, the new AMF 141 transmits a UE context request message to the old AMF 142 (S606). Here, the UE context request message transmitted by the new AMF may be “Namf_Communication_UEContextTransfer”. Further, the UE context transmitted from the new AMF 141 to the old AMF 142 (S606) may include the UE ID and the allowed NSSAI.

Next, the old AMF transmits a UE context response message to the new AMF as a response message to the received UE context request message (S608). Here, the old AMF may transmit the UE context to the new AMF 141, based on the reception of the UE context request message. Further, the response message transmitted by the old AMF may be “Response to Namf_Communication_UEContextTransfer”. Further, the old AMF may include the UE context and/or a Subscription Permanent Identifier (SUPI) in the UE context response message and transmit the UE context response message.

Note that in a case of carrying information related to AM policy association and UE policy association (i.e., a policy control request trigger for UE policy update), the old AMF may include this information in the UE context response message.

Further, in a case that the UE is performing the registration procedure in the roaming destination network (VPLMN), the old AMF may further include a V-PCF ID and an H-PCF ID in the UE context response message and transmit the UE context response message to the new AMF. Note that the V-PCF ID and the H-PCF ID received by the new AMF may be used in PCF selection (S610) and/or AM policy association establishment/modification (S612) and/or UE policy association establishment (S616), and/or the like, which will be described below. Details will be described below.

Further, in a case of receiving a UE context from the old AMF, the New AMF may generate a UE context, based on the UE context received.

Next, the new AMF performs the PCF selection (S610). Here, the PCF selection may be performed in a case that the new AMF determines to acquire a UE policy using the (V-) PCF identified by the (V-) PCF ID included in the UE context received from the old AMF (S608). Note that in a case that the UE is performing a registration procedure with the VPLMN, the AMF may select the V-PCF and acquire a UE policy from the selected V-PCF.

Next, the new AMF performs AM policy association establishment/modification (S612). Here, in a case that the new AMF selects a new (V-) PCF in the PCF selection (S610), the new AMF performs AM policy association establishment with the selected (V-) PCF. In S608, in a case that the old AMF uses the (V-) PCF identified by the (V-) PCF ID included in the UE context, AM policy association modification is performed.

Then, the new AMF 141 may transmit the control message to the UE based on the determination of the first condition fulfillment determination and/or based on the UE context received from the old AMF 142 (S614). The control message may be a registration accept message, or may be a registration reject message. Hereinafter, a case that the control message transmitted to the UE is a registration accept message will be described.

The new AMF 141 may include, in the control message, at least one or more pieces of identification information out of the third identification information and/or the fourth identification information, and transmit the control message. Note that by transmitting the identification information and/or the control message, the new AMF 141 may indicate that the network supports the function indicated by the identification information, may indicate that the request of the UE is accepted, may indicate that the request from the UE is not allowed or is not supported, or a combination of these information. The third identification information and the fourth identification information may be configured as a combination of the third identification information and the fourth identification information, or may be configured as identification information obtained by combining the third identification information with the fourth identification information. Note that whether to include the third identification information and/or the fourth identification information in the control message may be determined depending on the network capability, the operator policy, or the like.

For example, by transmitting the third identification information and/or the fourth identification information to the UE, the AMF may indicate that the UE has accepted the request indicated in the first identification information and/or the second identification information. Further, the UE and each apparatus may perform a procedure for using the URSP rules associated with the VPLMN during the present procedure or after completion of the present procedure, and may perform the UE policy delivery procedure described below.

Here, for example, the third identification information may be capability information indicating that the new AMF 141 and/or the core network supports the function corresponding to the capability information indicated by the first identification information received from the UE.

Further, by transmitting the third identification information, the AMF may indicate that the UE has accepted the request indicated in the first identification information and/or the second identification information. More specifically, for example, by transmitting the third identification information to the UE, the AMF may indicate that the network or each apparatus has accepted the request indicated by the UE in the first identification information and/or the second identification information or the use of the URSP rules associated with the VPLMN. In other words, in a case of receiving the third identification information, the UE may recognize that the network or each apparatus has accepted the use of the URSP rules associated with the VPLMN.

For example, even in a case that the first identification information and/or the second identification information is received from the UE, and the second identification information is not included in the control message that is the registration accept message, the new AMF 141 may indicate, for the UE, that the new AMF 141 and/or the core network recognizes the capability information of the UE indicated by the first identification information and/or the core network indicates, for the UE, that the new AMF 141 and/or the core network supports the function corresponding to the capability indicated by the first identification information.

Conversely, in a case that the third identification information is not included in the control message that is the registration message, the new AMF 141 may indicate, for the UE, that the new AMF 141 and/or the core network does not recognize the capability information of the UE indicated by the first identification information, and/or the core network may indicate, for the UE, that the new AMF 141 and/or the core network does not support the function corresponding to the capability indicated by the first identification information.

In a case of not receiving the first identification information from the UE, the new AMF 141 may transmit the control message including the third identification information, or transmit the control message without including the third identification information in the control message.

Here, the fourth identification information may be a response corresponding to the content of the request from the UE indicated by the second identification information received from the UE, and may indicate that the request from the UE is allowed. For example, in a case that the AMF accepts or permits the request of the UE indicated by the second identification information, the AMF may transmit the control message including the fourth identification information to the UE. Further, for example, in a case that the AMF accepts or allows the request of the UE indicated by the second identification information, the fourth identification information may be exclusively included in the control message.

In a case of not receiving the second identification information from the UE, the AMF may transmit the control message including the fourth identification information, or transmit the control message without including the fourth identification information in the control message.

Further, for example, in a case that the new AMF receives the first and/or second identification information from the UE, the new AMF may transmit a control message which is a registration accept message not including the third identification information and/or the fourth identification information, thereby indicating that the core network or the new AMF has accepted the content indicated by the first identification information and/or the second identification information received from the UE. In other words, in a case of receiving the first identification information and/or the second identification information from the UE, the AMF may transmit a registration accept message not including the third identification information and/or the fourth identification information to indicate that the UE has accepted the content requested by the first identification information and/or the second identification information.

On the contrary, in a case of rejecting the content indicated by the first identification information and/or the second identification information received from the UE, the new AMF may transmit a registration reject message to the UE to indicate that the new AMF has rejected the content indicated by the first identification information and/or the second identification information or the request of the UE. In a case of transmitting the registration reject message to the UE, the new AMF may further include a cause value indicating the cause of the rejection. Here, for example and without limitation, the cause value indicating the cause of the rejection may be a cause value indicating that the network or each apparatus does not support the use of the URSP rules associated with the VPLMN.

More specifically, for example, in a case of receiving the first identification information and/or the second identification information from the UE, the new AMF 141 may transmit a control message that is the registration accept message not including the third identification information and/or the fourth identification information to indicate, to the UE, that the new AMF 141 and/or the core network recognizes the capability information of the UE indicated by the first identification information and/or that the new AMF and/or the core network supports the function in which the core network deals with the capability indicated by the first identification information. Note that, for example, in a case that the new AMF transmits the registration reject message to the UE, the core network may indicate, to the UE, that the new AMF 141 and/or the core network does not recognize and/or fails to recognize the capability information of the UE indicated by the first identification information and/or that the new AMF and/or the core network does not support the function in which the core network deals with the capability indicated by the first identification information, the first identification information being received from the UE.

For example, in a case of receiving the first identification information and/or the second identification information from the UE, the new AMF 141 may transmit a control message that is the registration accept message not including the third identification information and/or the fourth identification information to indicate, to the UE, that the new AMF 141 and/or the core network recognizes the request of the UE indicated by the second identification information and/or that the new AMF 141 and/or the core network has accepted that the core network deals with the request indicated by the second identification information.

For example, in a case of receiving the first identification information and/or the second identification information from the UE, the new AMF 141 may transmit a control message that is the registration accept message not including the third identification information and/or the fourth identification information to indicate, to the UE, that the new AMF 141 and/or the core network recognizes the capability information of the UE indicated by the first identification information and/or the request of the UE indicated by the second identification information and/or that the new AMF 141 and/or the core network supports the function in which the core network deals with the capability indicated by the first identification information, and/or to indicate, to the UE, that the new AMF 141 and/or the core network has accepted that the core network deals with the request indicated by the second identification information.

In a case that the control message is a registration accept message, the AMF can either include an SM message (for example, a PDU session establishment accept message) in the registration accept message and transmit the message, or transmit an SM message (for example, a PDU session establishment accept message) together with the registration accept message. However, such a transmission method may be performed in a case that an SM message (for example, a PDU session establishment request message) is included in the registration request message. In addition, the transmission method may be performed in a case that the SM message (for example, the PDU session establishment request message) is transmitted along with the registration request message. By performing such a transmission method as described above, the AMF can indicate that a procedure for SM has been accepted in the registration procedure.

In addition, based on each piece of the received identification information, and/or subscriber information, and/or capability information of the network, and/or the operator policy, and/or a state of the network, and/or the subscription information of the user, and/or the context stored in the AMF, and/or the like, the AMF may indicate that the request from the UE has been accepted by transmitting a registration accept message, or may indicate that the request from the UE has been rejected by transmitting a registration reject message.

The UE receives the control message via the 5G AN (gNB) (S614). In a case that the control message is a registration accept message, then by receiving the registration accept message, the UE can recognize that the request from the UE on the registration request message has been accepted, and recognize the details of the various pieces of identification information included in the registration accept message. Alternatively, in a case that the control message is a registration reject message, then by receiving the registration reject message, the UE can recognize that the request from the UE using the registration request message has been rejected and recognize the details of the various pieces of identification information included in the registration reject message. In addition, in a case that the UE does not receive the control message even after a prescribed period of time has elapsed after transmitting the registration request message, the UE may recognize that the request from the UE has been rejected.

Furthermore, in a case that the control message is a registration accept message, the UE can further transmit to the AMF a registration complete message as a response message to the registration accept message via the 5G AN (gNB) (S618). Note that, in a case that the UE receives the SM message such as the PDU session establishment accept message, the UE may include the SM message such as the PDU session establishment completion message in the registration complete message and transmit the message, or may indicate that the procedure for SM has been completed by including the SM message. Here, although the registration complete message is a NAS message transmitted and/or received over the N1 interface, the registration complete message is transmitted and/or received between the UE and the 5G AN (gNB) by being included in an RRC message.

Then, the new AMF performs UE policy association establishment (S616). Here, the new AMF may establish the UE policy association by transmitting “Npcf_UEPolicyControl Create Request” to the PCF, and the PCF transmits “Npcf_UEPolicyControl Create Response ” to the new AMF.

Further, the PCF may trigger the UE policy delivery procedure. Details of the UE policy delivery procedure will be described in Section 3.1.2.

The AMF receives the registration complete message via the 5G AN (gNB) (S618). In addition, each apparatus completes the present procedure based on transmission and/or reception of the registration accept message and/or the registration complete message.

Alternatively, each apparatus may complete the registration procedure based on the transmission and/or the reception of the registration accept message or the registration reject message. Note that the UE policy delivery procedure performed during the present procedure may be continued even after completion of the registration procedure, or the registration procedure may be completed based on completion of the UE policy delivery procedure performed during the present procedure.

Note that each apparatus may transition to or maintain a state in which the UE is registered with the network (an RM_REGISTERED state or a 5GMM-REGISTERED state) based on the transmission and/or reception of the registration accept message and/or the registration complete message or may transition to or maintain a state in which the UE is not registered with the network (an RM_DEREGISTERED state or a 5GMM-DEREGISTERED state) over the access in which the UE has received the registration reject message for the current PLMN based on the transmission and/or reception of the registration reject message. In addition, the transition of each apparatus to each state may be performed based on transmission and/or reception of the registration complete message and completion of the registration procedure.

Furthermore, each apparatus may perform processing based on information transmitted and/or received in the registration procedure, based on completion of the registration procedure. For example, in a case that information indicating that a part of the request from the UE has been rejected is transmitted and/or received, the reason for rejection of the request from the UE may be recognized. Furthermore, each apparatus may perform the present procedure again or may perform the registration procedure on the core network_A or another cell based on the reason for the rejection of the request from the UE.

Moreover, the UE may store the identification information received along with the registration accept message and/or the registration reject message or may recognize determination of the network based on the completion of the registration procedure.

For example, in a case that in the registration procedure in the VPLMN, the UE receives the third identification information and/or the fourth identification information included in the registration accept message, the UE may recognize that the URSP rules associated with the VPLMN are delivered in the UE policy delivery procedure described below, which is performed during or after the present procedure, and that the use of the delivered URSP rules has been allowed.

Further, for example, the UE may recognize that the network supports the delivery of the URSP rules associated with the VPLMN in a case that the UE receives the third identification information and/or the fourth identification information included in the registration accept message during the registration procedure in the VPLMN.

Note that in a case of receiving, in the registration procedure in the VPLMN, the registration accept message including neither of the third identification information and the fourth identification information, the UE may recognize that the URSP rules associated with the HPLMN are delivered and that the use of the URSP rules to be delivered has been allowed.

Note that in a case of receiving, in the registration procedure in the VPLMN, the registration accept message including neither of the third identification information and the fourth identification information, the UE may recognize that the network does not support the delivery of the URSP rules associated with the VPLMN.

### [3.1.2. UE Policy Delivery Procedure]

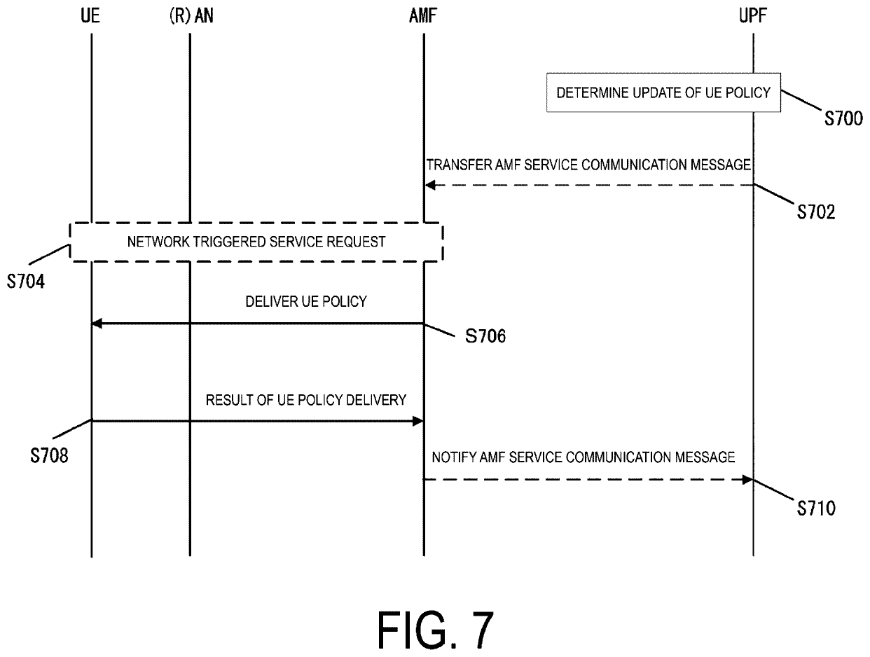

Next, the UE policy delivery procedure will be described by using FIG. 7. Here, the UE policy delivery procedure is a procedure initiated by the PCF for updating the configuration of the UE, and may be a procedure for providing, by the PCF, the policy in a UE-transparent manner. Here, transparent means that the UE policy transmitted by the PCF is not changed by the AMF and is delivered to the UE by using a transparent container. The UE policy delivered in the present procedure may be the URSP rules, and the URSP rules may be associated with the HPLMN or the VPLMN.

Note that the UE policy delivery procedure may be a UE Configuration Update procedure for transparent UE Policy delivery. The UE policy delivery procedure is hereinafter also referred to as the present procedure. Note that the present procedure may be a procedure that can be performed after completion of PCF selection (S610) and AM policy association establishment/modification (S612), which are performed by the AMF.

The present procedure may be a Network-requested UE policy management procedure and a procedure in which the PCF transmits, to the UE, a “Manage UE policy command” including UE policy information. Here, the “Manage UE policy command” may be a message transmitted to the UE as a DL NAS transport message. Note that the detailed procedure of the network-requested UE policy management procedure may be equivalent to the procedure of the UE configuration update procedure for transparent UE policy delivery.

The present procedure may be performed at any timing during the above-described registration procedure or after completion of the registration procedure. Here, in a case that the present procedure is performed during the registration procedure, the procedure may be initiated by being triggered by the PCF in the above-described UE policy association establishment (S616).

The present procedure may be a procedure performed in a case that the UE is performing the registration procedure with the VPLMN which is the roaming destination network or has completed the registration procedure with the VPLMN. Here, the UE policy delivered to the UE residing in the VPLMN may be URSP rules generated by the V-PCF and associated with the delivering VPLMN.

Further, the present procedure may be performed while the UE is registered with or connected to the HPLMN or the VPLMN which is the roaming destination network. More specifically, the present procedure may be performed by the UE during the registration procedure with the VPLMN to the HPLMN, or may be initiated by the network or the PCF at any timing after the completion of the registration procedure with the HPLMN or the VPLMN. Note that the PCF in a case that the present procedure is performed in the VPLMN may be the V-PCF.

In the present procedure, first, the PCF determines to update the UE policy (S700). Here, the determination of the UE policy update by the PCF may be based on the registration procedure, the need for the UE policy update, or the like. In other words, the PCF may perform the present procedure during the registration procedure or may perform the present procedure at any timing after the completion of the registration procedure in a case that the update of the UE policy is required. Note that the registration procedure may be an initial registration procedure.

More particularly, for example, the determination of the UE policy update by the PCF in the UE policy delivery procedure performed during the registration procedure may be based on a determination of whether the UE policy information is to be provided to the UE via the New AMF (AMF) using a DL NAS TRANSPORT message after the UE policy information is updated based on a comparison of a policy section identifier (PSI) list included in the UE policy information included in the Npcf_UEPolicyControl_Create Request message transmitted by the AMF to the PCF in the S616 procedure described in Section 3.1.1.

Alternatively, for example, the determination of UE policy update by the PCF in the UE policy delivery procedure initiated by the network and performed at any timing initiated by the network may be based on the PCF checking the up-to-date PSI list and determining the UE policy that needs to be transmitted to the UE.

Then, after determining the update of the UE policy, the PCF transmits a message to the AMF using an AM service communication message transfer service (S702). Here, the message transmitted from the PCF to the AMF may be transmitted by the PCF performing a “Namf_Communication_NIN2MessageTransfer” service operation provided by the AMF. Further, the message transmitted from the PCF to the AMF may include the SUPI and the UE policy container.

Note that in a case of determining that the size of the UE policy information exceeds a predefined limit, the PCF may divide the UE policy information into logically independent UE policies with a size less than the limit, and perform the

“Namf_Communication_N1N2MessageTransfer” service operation multiple times for transmission.

Here, the UE policy transmitted from the PCF to the AMF in S702 may be the URSP rules. To be more specific, for example, in the registration procedure in the VPLMN, in a case that the UE transmits, to the network, the registration request message including the first identification information and/or the second identification information, the content indicated by the one or more pieces of identification information is accepted by the network, and the registration procedure is completed, then the UE policy transmitted from the V-PCF to the (V-) AMF in S702 may be the URSP rules associated with the VPLMN generated by the V-PCF.

Then, in a case of receiving the message transmitted from the PCF by the “Namf_Communication_N1N2MessageTransfer” service operation (S702), the AMF performs a network triggered service request (S704). Note that the network triggered service request may be a service request procedure initiated by the network or the AMF, and may be performed in a case that the UE is in a registered state (RM-REGISTERED state) and in a non-connected state (CM-IDLE state). In other words, in a case that the UE is in the registered state (RM-REGISTERED state) and the connected state (CM-CONNECTED state), the network triggered service request (S704) need not be performed.

After completing S702 and/or S703, the AMF performs the delivery of the UE policy (S706). Here, the delivery of the UE policy may include transmitting, by the AMF, the DL NAS transport message including the UE policy information to the UE. Note that the UE policy included in the DL NAS transport message may be the URSP rules.

Further, the URSP rules received in S706 may be the URSP rules associated with the VPLMN in a case that the UE transmits the first identification information and/or the second identification information included in the registration request message during the registration procedure in the VPLMN, and the content of the first identification information and/or the second identification information is accepted by the network.

Before the UE receives the URSP rules from the network in S706, the UE may store the URSP rules in advance. More specifically, the UE may have stored the URSP rules associated with the HPLMN and/or the URSP rules associated with the VPLMN. Further, in a case that the UE receives the URSP rules from the network in S706, the UE may perform management such as storage, update or replacement, or deletion for each PLMN associated with the received URSP. The UE may store and manage the URSP rules for each PLMN. In other words, for example, the UE may independently store and manage the URSP rules associated with the VPLMN or the HPLMN.

Here, the case where the UE deletes the URSP rules may be a case where the URSP rules received by the UE from the network in S706 are empty (“empty” or “0”), and the empty URSP rules may be processed for each PLMN. In other words, in a case that the URSP rules for a particular PLMN are empty and in a case that the UE already stores the URSP rules corresponding to the PLMN, the UE may delete the corresponding URSP rules. In other words, in a case that the URSP rules stored in the UE are deleted, the PCF may set, in generating URSP rules, the URSP rules to be empty, the URSP rules corresponding to the PLMN as a deletion target.

Here, in a case of receiving the URSP rules from the PCF via the AMF in S706, the UE may behave as follows.

For example, in a case of transmitting, to the network in the VPLMN, the registration request message including the first identification information and the second identification information to complete the registration procedure, the UE may store, in association with the VPLMN, the URSP rules associated with the VPLMN received in S706 of the UE policy delivery procedure during the registration procedure or after completion of the registration procedure. Further, in a case of receiving new URSP rules associated with the same VPLMN in S706 of the UE policy delivery procedure performed during another registration procedure or after completion of the registration procedure, the UE may update or replace the already stored, old URSP rules associated with the VPLMN with the new URSP rules. Further, in a case of receiving empty URSP rules associated with the same VPLMN in S706 of the UE policy delivery procedure performed during another registration procedure or after completion of the registration procedure, the UE may delete the already stored, old URSP rules associated with the VPLMN.

For example, in a case of receiving the URSP rules associated with the VPLMN in S706 of the UE policy delivery procedure performed during another registration procedure or after completion of the registration procedure, a UE already storing the URSP rules associated with the HPLMN and connected to the VPLMN may store the received URSP rules associated with the VPLMN without deleting the already stored URSP rules associated with the HPLMN.

For example, in a case of receiving the URSP rules associated with the VPLMN in S706 of the UE policy delivery procedure performed during another registration procedure or after completion of the registration procedure, a UE not supporting the URSP rules associated with the VPLMN need not store the received URSP rules associated with the VPLMN or may ignore the received URSP rules associated with the VPLMN.

Note that the behavior of the UE, having received the URSP rules from the PCF via the AMF in S706, is not limited to the behavior described above.

In a case of receiving the UE policy from the PCF via the AMF, the UE updates the UE policy and transmits the delivery result for the UE policy to the AMF (S708).

In a case of receiving the delivery result for the UE policy from the UE, the AMF transmits a message to the PCF using an AMF service communication message notification service (S710). Here, more specifically, the message transmitted from the AMF to the PCF transfers the UE policy container received by the AMF from the UE, using the “Namf_Communication_N1MessageNotify” service operation. Note that S710 may be performed in a case that the PCF subscribes to reception of an acknowledgement of the UE policy container.

Further, the PCF maintains and stores the up-to-date PSI list delivered to the UE in the present procedure and updates the up-to-date PSI list in the UDR using a Nudr_DM_Update (SUPI, Policy Data, Policy Set Entry, updated PSI data) service operation.

### 3.2. First Embodiment

A first embodiment of the present invention relates to the behavior performed by the UE in a case that in the registration procedure with the VPLMN, the UE does not indicate the support of and/or the request for the use of the URSP rules associated with the VPLMN, and during the registration procedure or after completion of the registration procedure, the network or each apparatus of the network transmits, to the UE, the URSP rules associated with the VPLMN. Note that the first embodiment is referred to as the present embodiment in the present section.

Here, the case where the UE has not indicated the support of and/or the request for the use of the URSP rules associated with the VPLMN in the registration procedure with the VPLMN may be a case where the UE transmits, to the network (VPLMN), a registration request message including neither of the first identification information and the second identification information. In other words, the UE may perform the registration procedure and the registration procedure with the VPLMN without, for the network (VPLMN), supporting the use of the URSP rules associated with the VPLMN or requesting the network (VPLMN) to use the UPSP rules associated with the VPLMN.

In the registration procedure with the VPLMN, the UE transmitting the registration request message including neither of the first identification information and the second identification information may be a UE not supporting the use of the URSP rules associated with the PLMN.

More specifically, the present embodiment may correspond to, for example, a case where the registration procedure is completed in the registration procedure with the VPLMN, by transmitting, by the UE, the registration request message including neither of the first identification information and the second identification information to the network, and transmitting, by the network, the registration accept message to the UE.

In a case of receiving the URSP rules associated with the VPLMN in the UE policy delivery procedure during the registration procedure or after completion of the registration procedure, the UE may transmit a message indicating that the UE policy delivery has failed, to the AMF as a result of the UE policy delivery (S708). Further, the UE need not store the received URSP rules associated with the VPLMN.

### 3.3. Second Embodiment

A second embodiment of the present invention relates to the behavior performed by the UE in a case that in the registration procedure with the VPLMN, the UE indicates the support of and/or the request for the use of URSP rules associated with the VPLMN, and during the registration procedure or after completion of the registration procedure, the network or each apparatus of the network transmits, to the UE, the URSP rules associated with the VPLMN and URSP rules associated with the HPLMN. Note that the second embodiment is also referred to as the present embodiment in the present section.

In other words, the present embodiment may correspond to a case where the registration procedure is completed in the registration procedure with the VPLMN, by transmitting, by the UE, the registration request message including the first identification information and/or the second identification information to the network, and transmitting, by the network, the registration accept message to the UE.

In a case of receiving the URSP rules associated with the HPLMN and the URSP rules associated with the VPLMN during the registration procedure or after completion of the UE policy delivery procedure, the UE may store the received URSP rules for each PLMN. Further, the UE may preferentially use the URSP rules associated with the VPLMN that is the serving PLMN.

### 4. Modifications

A program running on an apparatus according to the present invention may serve as a program that controls a Central Processing Unit (CPU) and the like to cause a computer to operate in such a manner as to realize the functions of the embodiment according to the present invention. Programs or information handled by the programs are temporarily stored in a volatile memory such as a Random Access Memory (RAM), a non-volatile memory such as a flash memory, a Hard Disk Drive (HDD), or another storage apparatus system.

Note that a program for realizing such the functions of the embodiment according to the present invention may be recorded on a computer-readable recording medium. The functions may be realized by causing a computer system to read the program recorded on the recording medium and execute the program. It is assumed that the “computer system” refers to a computer system built into the apparatuses, and the computer system includes an operating system and hardware components such as a peripheral device. Furthermore, the “computer-readable recording medium” may be a semiconductor recording medium, an optical recording medium, a magnetic recording medium, a medium dynamically holding the program for a short time, or any other computer readable recording medium.

In addition, each functional block or various features of the apparatuses used in the aforementioned embodiments may be implemented or performed on an electric circuit, for example, an integrated circuit or multiple integrated circuits. An electric circuit designed to perform the functions described in the present specification may include a general-purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or may be a known processor, a controller, a micro-controller, or a state machine. The aforementioned electric circuit may include a digital circuit or may include an analog circuit. In addition, in a case that a circuit integration technology that replaces the present integrated circuits appears with advances in semiconductor technologies, one or multiple aspects of the present invention can also use a new integrated circuit based on the technology.

Note that the invention of the present application is not limited to the above-described embodiments. Although apparatuses have been described as an example in the embodiments, the invention of the present application is not limited to these apparatuses, and is applicable to a terminal apparatus or a communication apparatus of a fixed-type or a non-stationary electronic apparatus installed indoors or outdoors, for example, an AV apparatus, a kitchen apparatus, a cleaning or washing machine, an air-conditioning apparatus, office equipment, a vending machine, and other household apparatuses.

Although, the embodiments of the present invention have been described in detail above referring to the drawings, the specific configuration is not limited to the embodiments and includes, for example, design changes within the scope that do not depart from the gist of the present invention. Furthermore, in the present invention, various modifications are possible within the scope of claims, and embodiments that are made by suitably combining technical means disclosed according to the different embodiments are also included in the technical scope of the present invention. In addition, a configuration in which elements described in the respective embodiments and having mutually similar effects are substituted for one another is also included.

### CROSS-REFERENCE OF RELATED APPLICATION

The present application claims priority of JP 2022-022067, filed on Feb. 16, 2022, and all the contents thereof are included herein by the reference.

### REFERENCE SIGNS LIST

1 Mobile communication system
10 UE_A
30 PGW-U
32 PGW-C
35 SGW
40 MME
45 eNB
50 HSS
60 PCRF
80 Access network_A (E-UTRAN)
90 Core network_A
120 Access network_B (5G AN)
122 gNB
130 UPF
132 SMF
140 AMF
141 new AMF
142 old AMF
150 UDM
160 PCF
190 Core network_B

1-3. (canceled)

4. A User Equipment (UE) comprising:
transmission and reception circuitry;
storage circuitry; and
controlling circuitry wherein
the transmission and reception circuitry is configured to transmit first information to a network,
in a case that the transmission and reception circuitry receives a Manage UE policy command including information related to a first UE Route Selection Policy (URSP) associated with a first Visited Public Land Mobile Network (VPLMN) in a UE policy management procedure, the controlling circuitry is configured to store information related to the first URSP into the storage circuitry, and
the first information indicates that the UE supports information related to a URSP associated with a VPLMN.

5. The UE according to claim 4, wherein
in a case that the transmission and reception circuitry further receives information related to a second URSP associated with the first VPLMN, the controlling circuitry is configured to replace the information related to the first URSP stored in the storage circuitry with the information related to the second URSP.

6. A communication control method performed by a User Equipment (UE), the communication control method comprising:
transmitting first information to a network; and
in a case that a Manage UE policy command including information related to a first UE Route Selection Policy (URSP) associated with a first Visited Public Land Mobile Network (VPLMN) in a UE policy management procedure is received, storing information related to
the first URSP into the UE,
wherein the first information indicates that the UE supports information related to a URSP associated with a VPLMN.
